(19) United States
(12) Patent Application Publication
(10) Pub. No.: US 2014/0162237 A1
(43) Pub. Date: Jun. 12, 2014

(54) INTERACTIVE ASSIGNMENT SYSTEM INCLUDING A SIMULATION SYSTEM FOR SIMULATING MODELS OF PROBLEMS

(71) Applicant: Franco Capaldi, Andover, MA (US)

(72) Inventor: Franco Capaldi, Andover, MA (US)

(21) Appl. No.: 13/708,671

(22) Filed: Dec. 7, 2012

(51) Int. Cl. G09B 7/00

(52) U.S. Cl. CPC G09B 7/00
USPC 434/350

(57) ABSTRACT

An interactive assignment system to present problems to users. The interactive assignment system may include a simulation system to simulate interactions of objects of a model of the problem. The simulation system may be configured to determine characterizations of properties of the model based on simulating the interactions. The interactive assignment system may enable users to input a characterization of a property of the model, and the simulation system may determine a correct characterization from evaluating the model. The users' input may then be compared to the correct characterization to determine whether the users' input is correct. Similarly, the interactive assignment system may enable a user configuring a problem (such as an instructor for a course) merely to indicate a property of the model to which a desired solution relates, and the simulation system may determine a correct characterization of the property from evaluating the model.

### BACKGROUND

Homework, problem sets, examinations, and other forms of assignments have long been assigned by instructors to students as part of the educational process in many different fields. Traditionally, such assignments were completed by students using pen and paper. Recently, however, advancements in computer technology enabled the delivery of assignments from instructors to students via computers, and the delivery of solutions to those assignments from students to instructors via those same computers.

Computer-based assignment distribution systems provide functionality that minors the way in which assignments were traditionally completed on pen and paper. Instructors would provide to the assignment distribution system a statement of the problem (and in some cases an illustration of the problem) and the solution to the problem. The assignment distribution system would then display that problem statement (and, if applicable, the illustration) to each student via a user interface of the assignment distribution system and would prompt the students to provide the solution as input. The system would then perform a comparison between the student's input solution and the instructor's input solution. If there was an exact match between the student's solution and the solution provided by the instructor, the student's input would be marked correct.

### SUMMARY

In one embodiment, there is provided a method of operating an interactive assignment system to configure a problem to be presented via the interactive assignment system. The interactive assignment system operates on at least one computing device and comprises a simulation system to simulate interactions of objects in a model of the problem and to determine an effect of interactions of objects in the model. The method comprises configuring the model of the problem based at least in part on user input, the configuring comprising storing information indicating that a value of a property of the model is to be randomly selected when the simulation system is to simulate the model. The method further comprises configuring the problem with a desired solution that is to be input to the interactive assignment system as a solution to the problem, in response to receipt of user input indicating the desired solution.

In another embodiment, there is provided at least one computer-readable storage medium having encoded thereon computer-executable instructions that, when executed by at least one computer, cause the at least one computer to carry out a method of operating an interactive assignment system to configure a problem to be presented via the interactive assignment system. The interactive assignment system operates on at least one computing device and comprises a simulation system to simulate interactions of objects in a model of the problem and to determine an effect of interactions of objects in the model. The method comprising configuring the model of the problem based at least in part on user input, the configuring comprising storing information indicating that a value of a property of the model is to be randomly selected when the simulation system is to simulate the model. The method further comprises configuring the problem with a desired solution that is to be input to the interactive assignment system as a solution to the problem, in response to receipt of user input indicating the desired solution.

In a further embodiment, there is provided an apparatus comprising at least one processor and at least one storage medium having encoded thereon executable instructions that, when executed by at least one processor, cause the at least one processor to carry out a method for generating a problem to be presented via an interactive assignment system. The interactive assignment system comprises a simulation system to simulate interactions of objects in a model and to determine an effect of interactions of objects in the model. The method comprises receiving a configuration of the model of the problem, the configuration indicating that a property of the model is to be randomly selected, randomly selecting a value of the property of the model in accordance with the configuration, rendering the model for display, and outputting the problem for presentation via the interactive assignment system. The outputting comprises outputting a rendering of the model and a prompt for a solution to the problem.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an illustration of a computer system in which some embodiments may operate;

FIG. 2 is a block diagram of examples of computing devices and components of an interactive assignment system;

FIG. 3A-3D are images of an exemplary user interface that may be implemented by an interactive assignment system in some embodiments;

FIG. 4 is a flowchart of an exemplary process that may be implemented by an interactive assignment system for configuring a problem in response to receiving input regarding the problem from an instructor;

FIG. 5 is a flowchart of an exemplary process that may be implemented by an interactive assignment system for configuring a model of a problem in response to receiving input regarding the model from an instructor;

FIG. 6 is a flowchart of an exemplary process for evaluating a configuration of a model created based on input from an instructor;

FIG. 7 is a flowchart of an exemplary process for interacting with a student via an interactive assignment system to present a problem to the student and receive from the student a characterization of a property of the model;

FIG. 8 is a flowchart of an exemplary process for rendering a model for presentation to a student based on a configuration indicating that the model includes a property that is to be randomly selected;

FIG. 9 is a flowchart of an exemplary process for evaluating a student's input to determine whether the student has provided a solution to a problem;

FIG. 10 is a flowchart of an exemplary process for determining whether a student's input characterization is correct, which may be implemented in some embodiments for evaluating an input characterization that is a numeric value;

FIG. 11 is a flowchart of another exemplary process for determining whether a student's input characterization is correct, which may be implemented in some embodiments for evaluating an input characterization that is an expression;

FIG. 12 is a flowchart of another exemplary process for determining whether a student's input characterization is correct, which may be implemented in some embodiments for evaluating an input characterization that is an expression;

FIG. 13 is a flowchart of another exemplary process for determining whether a student's input characterization is coincidentally correct for the specific numeric values of a model of a problem, which may be implemented in some embodiments for evaluating an input characterization that is an expression;

FIG. 14 is a flowchart of another exemplary process for determining whether a student's input characterization is correct, which may be implemented in some embodiments for evaluating an input characterization that is a second model related to the model of the problem;

FIG. 15 is a flowchart of an exemplary process for presenting a problem to a student via a user interface of the interactive assignment system that is arranged to accept student input in a format identified by a configuration of the problem;

FIG. 16 is a flowchart of an exemplary process for presenting an educational message to a student in response to detecting that the student's incorrect input includes an indication of a common mistake;

FIG. 17 is a flowchart of an exemplary process for determining options to be presented to a student via a user interface when a configuration of a problem indicates that the problem should be presented to the student in a multiple choice format; and

FIG. 18 is a block diagram of an exemplary computing device with which some embodiments may operate.

### DETAILED DESCRIPTION

Applicant has recognized and appreciated the advantages of an interactive assignment system that includes a simulation system and that presents problems to students that include models, where the models are used by the simulation system to carry out simulations related to the problems. Such a system, for examples, may enable a student to interact with a problem in ways other than providing a desired solution identified by an instructor. A problem that is presented via such an interactive assignment system may include an identification of a property of the model to which a desired solution to the problem relates and the interactive assignment system may accept as input from a student a characterization of the property to which the desired solution relates. The interactive assignment system may additionally accept as input from the student characterizations of properties of the model other than the property to which the desired solution relates. Such an interactive assignment system may exchange information with the student regarding one or more properties of the model other than the property related to the desired solution, such as in response to receiving a characterization of a property from the student. A simulation system of the interactive assignment system may carry out simulations based on the model of the problem to determine information to be provided to the student or that is used to evaluate the student's input.

Applicant has recognized and appreciated that currently-available assignment distribution systems are limited to informing a student of whether the student's input precisely matches a previously-stored solution to the problem, such as a solution input and stored by an instructor who created the problem. Such systems limit students to providing input regarding only the desired solution and do not allow students to provide input regarding other parts of a problem. For example, currently-available assignment distribution systems do not permit students to explore other parts of a problem to test their knowledge of these other parts of the problem. The assignment distribution systems therefore do not provide the same learning opportunities as an interactive system. Applicant has recognized and appreciated that permitting students to explore parts of a problem other than the desired solution may be beneficial to the learning process. By exploring other parts of a problem, students could self-test their own knowledge of these other parts of the problem. Additionally, if a student is uncertain of how to calculate a desired solution, allowing the student to explore other parts of the problem may enable the student to iteratively work through the problem until the student determines on their own how to arrive at the desired solution.

Applicant has also recognized and appreciated that, because currently-available assignment distribution systems are limited to determining whether a student's input is an exact match of an instructor's input, in some cases a student's correct input may be marked incorrect. For example, a student may input a numeric value or an expression that is equivalent to an instructor's correct numeric value or expression, such as by using a different notation or different sets of units for a numeric value or by using a different but equivalent function in an expression. In these assignment distribution systems, however, the student's input may be marked incorrect, despite that the student's input was correct, because the input is not a precise match of the instructor's answer. Applicant has recognized that this may prevent students from exploring creative ways to solve problems, including ways an instructor may not have considered, as the students are not provided feedback on these other inputs or are told these other inputs are incorrect.

Applicant has further recognized and appreciated that such assignment distribution systems are limited in the creation of problems and storage of desired solutions. An instructor creating a problem to be provided to a student is required to provide to the system the solution that the instructor wants the student to input. Such a system requires that the instructor compute the solution and input that solution to the system, which in some cases could require a great deal of the instructor's time.

In view of the foregoing, Applicant has recognized and appreciated the advantages of interactive assignment systems that include simulation systems for evaluating models of problems that are to be presented to students. A model of a problem may describe a scenario to which a problem relates. As one example, if a problem relates to the forces in a truss, the truss is a scenario and the model may describe the beams and joints included in the truss. In cases where a scenario includes multiple physical objects that interact, the model may include objects that correspond to the physical objects and the simulation system may simulate interactions of the objects of the model. The simulation performed by the simulation system may include determining characterizations of properties of the model, including properties of objects of the model, based on properties of the model defined by an instructor when the instructor provides input or which the interactive assignment system configures the model. The simulation may also include determining characterizations of properties of the model based at least in part on definitions of the model and/or objects of the model, such as properties that are built into the objects that the instructor indicated should be included in the model or default properties of models.

Simulating interactions of objects of the model may include performing calculations based on the manner in which an instructor has arranged objects in the model or otherwise defined the model to operate. A simulation system may be configured with functions that correspond to physical laws that govern interactions of physical objects. The simulation system may, in some cases, apply the functions that correspond to the physical laws to determine an effect of interactions of objects of a model. Applying these functions may include performing processing to determine characterizations of one or more properties of the model.

A characterization of a property may include any suitable information describing the property, including information defining the property. A characterization may be in any suitable form, as embodiments are not limited in this respect. In some cases, a characterization of a property may include a value, such as a numeric value, of the property and/or units of a numeric value. In other cases, a characterization may include a mathematical expression relating to a property, which may be an equation defining the property. In still other cases, a characterization of a property may include a second model relating to the property that may be simulated by the simulation system. The second model that is a characterization of a property may be a second model that is related to the model of the problem. For example, in some cases a characterization may be a free body diagram of the model or a reduced or otherwise simplified form of the model of the problem.

Depending on a type of characterization to be determined through simulating, a simulation system may perform various types of processing based on a model to determine a characterization of a property. For example, in some cases, the simulation performed by the simulation system based on the model may include applying one or more functions to calculate a numeric value of a property. The functions that are applied may perform calculations based on the model, such as by performing calculations on numeric values of properties of the model. As another example, in some cases, the simulation performed by the simulation system may include determining an expression defining a property of a model, such as by evaluating expressions defining other properties of a model and evaluating a manner in which objects of the model are arranged, including positions of objects and positions of points of interaction between objects. The simulation system may perform any suitable processing as part of simulating a model to determine characterizations of objects of a model.

A simulation system may be configured to determine characterizations of any suitable properties of a model, including properties to which a desired solution relates and other properties that are not related to a desired solution. Properties of a model for which characterizations may be determined may include any suitable properties of objects of a model or of interactions of objects of a model. Properties of a model or of an object may describe the object or the interactions or describe a result of the interactions. In cases where objects of a model correspond to physical objects, properties of the model and of the objects may correspond to physical attributes of physical objects or of combinations of physical objects.

In some embodiments, an interactive assignment system that includes a simulation system to simulate models of problems may operate in at least two modes.

In a first mode, an interactive assignment system may configure a problem based on input received from an instructor. The instructor may provide input regarding a model of the problem. In some embodiments in which an instructor defining a problem intends for a student to provide a specific input, such as an input to be graded, the instructor may also provide input regarding the instructor's desired solution to the problem. The input regarding the desired solution to the problem may be in any suitable form, as discussed below. In some embodiments, the instructor may identify a property of a model to which the solution relates and the interactive assignment system may determine a characterization of that property that is the correct solution. It should be appreciated that, in some embodiments, a problem may be configured without a desired solution. For example, in some cases, a student may be given the problem to assist the student in learning certain subject matter through exploring the problem and exploring the model of the problem, but the student is not requested to provide any particular input. This may be the case with an in-class assignment, a supplemental assignment, an ungraded assignment, an assignment that may not be reviewed by the instructor, or other types of assignments that may be presented to students by instructors.

The interactive assignment system may receive any suitable input regarding a model. For example, the system may receive, from an instructor, input identifying objects to be included in a model, positions of objects in the model and locations at which the objects interact, and information regarding properties of objects in the model. From this input, the interactive assignment system may configure the model to be simulated by the simulation system. In some cases, information regarding the model that is received from an instructor may include information specifying that at least one property of a model is to be randomly selected by the simulation system prior to simulating using the model. By specifying that a property of the model is to be randomly selected prior to simulating, the instructor can have the system create multiple different problems through providing input to configure one problem. For example, in some embodiments, when a problem is to be presented to multiple users and a property of the model of the problem is to be randomly selected, the model that results from the random selection may be different for each of the students. When the model that results is different, a desired solution may vary as well, which results in variations of the original problem that may be presented to each of the students without the instructor needing to individually configure each of the multiple different problems. In embodiments in which an interactive assignment system can configure a problem to indicate that a property is to be randomly selected, any suitable property of a model may be randomly selected. For example, a location of an interaction between objects of the model may be randomly selected, such that the objects may interact at different locations for different students. As another example, properties of objects of a model may be randomly selected, such as properties of objects that correspond to physical attributes of physical objects that the objects of the model are to simulate.

In the first mode, in some embodiments, the interactive assignment system may also receive any suitable information regarding a desired solution. In some embodiments, the interactive assignment system may receive from the instructor a characterization of the property to which the desired solution relates. In other embodiments, however, information regarding the desired solution that is received from an instructor may merely include an identification of a property to which the desired solution relates, such as a property of the model for which the instructor wishes students to input a characterization. In some such embodiments, following the instructor identifying the property to which the desired solution relates, the interactive assignment system may determine the desired solution through simulating, with the simulation system, interactions of objects in the model. Through the simulating, the interactive assignment system may determine at least one characterization of the property to which the desired solution relates.

In a second mode, an interactive assignment system may present a problem to a student and exchange information with the student regarding the problem. The information that is received from the student may include a characterization of a property of a model. In response to receiving the characterization of the property, the interactive assignment system may provide information to the student regarding the property. Information that is provided to the student may, in some embodiments, include information relating to whether the student's input characterization is a correct characterization of the property. If the student's input characterization is correct, then the interactive assignment system may notify the student.

Further, in the second mode, the interactive assignment system may, in some embodiments, determine whether a student's input characterization of a property is only a coincidentally correct characterization of the property. By determining whether the correct input characterization is only coincidentally correct, the system may determine whether the input characterization is correct only in the case of the specific numeric values of the model of the presented problem or whether the student's input characterization is a correct description of the property for different numeric values. For example, a problem presented via an interactive assignment system may relate to a truss and a student may input as a characterization that the tension in one beam of the truss is equivalent to the tension in another beam of the truss. In the problem, as a result of the properties configured in response to an instructor's input, it may be the case that the tension in both beams is 10 Newtons, and therefore it is correct that the tension in the beams is equivalent. However, it may be the case that the same truss, with slightly different properties, may have different tensions in the beams, and it may therefore be merely a coincidence that the beams have the same tension. In this case, informing the student that the input characterization is correct may lead to the student mistakenly believing that the tensions will always be equal in trusses of this type. To prevent such a result, in some embodiments, the interactive assignment system may determine, when a student's input characterization is correct for the model, whether the student's input is also correct for variations of the model and therefore whether the student's input is more than merely coincidentally correct. Accordingly, in some embodiments, the interactive assignment system may provide a student with information regarding whether an input characterization is coincidentally correct.

Additionally, in some embodiments, in a case that the student's input is incorrect, the student's input may be evaluated for whether there are indications of common mistakes in the characterization. The interactive assignment system may be configured with information regarding common mistakes committed by students, such as errors by mistakenly switching trigonometric functions or using the wrong units in a function. In the case that the interactive assignment system determines that a student's input shows signs of a common mistake, the interactive assignment system may provide information to the student regarding the mistake. Providing the information about the mistake may, in some embodiments, include displaying an educational message teaching the student about the mistake.

In some embodiments, an interactive assignment system may be configurable to provide more or less information to a student in a case that the student's input characterization is incorrect. More particularly, the interactive assignment system may be configurable to provide different types or amounts of information to a student in the case that a student's input characterization is incorrect. The interactive assignment system may be configurable based at least in part on a type of assignment that is to be provided to a student by the interactive assignment system. For example, the interactive assignment system may be operable to provide problems to be performed as homework by a student as well as problems to be performed as part of an examination. In the case of a homework assignment, the interactive assignment system may be configured by the instructor to provide information to a student to assist the student in learning material, and in this case the system may provide educational messages to a student informing the student of common mistakes that were detected. In the case of an examination, however, the interactive assignment system may be configurable not to provide information to the student, such that the student is expected to complete the examination problem by him- or herself without assistance.

Additionally, in some embodiments, as a student interacts with the system to provide characterizations and receive information from the system regarding those characterizations, the system may log information regarding the exchanges with the student. The interactive assignment system may provide these logs to an instructor, which may aid the instructor in determining how a single student is progressing or how multiple students of a class are progressing. For example, if a student requests the instructor's assistance with a problem that was presented to the student via the interactive assignment system, the instructor may be able to review the student's previous interactions with the system regarding the problem and potentially determine a source of the student's error. As another example, the instructor may be able to review the interactions of multiple students with the system regarding a problem and identify concepts to be reviewed in a class, such as by identifying errors that appear in multiple students' interactions with the system.

Features of various embodiments of an interactive assignment system have been described. Exemplary embodiments are described below that include one or more of the features described above. It should be appreciated that embodiments are not limited to implementing all or any particular combination of the features described above, and that embodiments are not limited to being implemented according to any of the illustrative examples below.

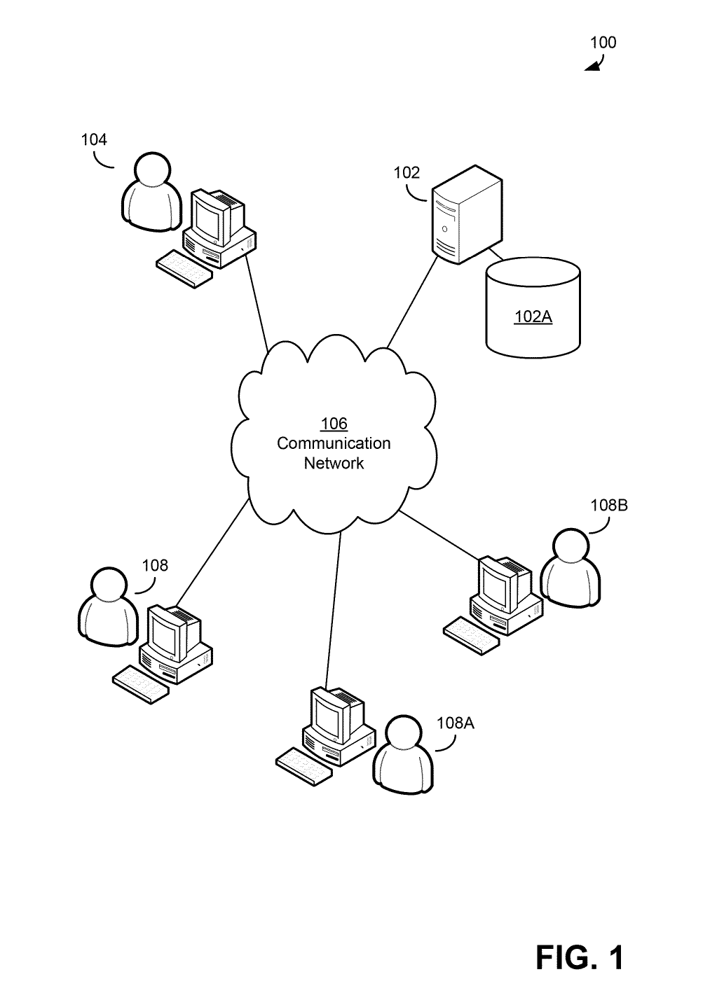

FIG. 1 is an illustration of a computer system in which some embodiments may operate. Computer system 100 includes a computing device 102 on which an interactive assignment system may execute. As discussed above, the interactive assignment system executing on the computing device 102 may perform operations related to interacting with students regarding assignments. Such interaction may include presenting to students problems that have been created by instructors and processing input provided by the students. An interactive assignment system may, for example, determine whether input provided by a student is correct and interact with the student regarding the input.

As illustrated in FIG. 1, computing device 102 may include a data store 102A for storing information to be used by the interactive assignment system executing on computing device 102. The information stored by the data store 102A for use by the interactive assignment system may include any suitable information regarding problems and/or students. For example, information stored in the data store 102A may include configurations of one or more problems that are to be presented by the interactive assignment system to a student. As mentioned above and as discussed in greater detail below, a configuration of a problem may include information that describes the problem and that may be used by the interactive assignment system to present the problem to a student and/or to evaluate input provided by a student. For example, a configuration of a problem may include a configuration of a model of the problem and information regarding a desired solution of the problem that is to be provided by the student to solve the problem. The configuration of the model of a problem may include information regarding one or more objects included in the model, such as information regarding properties of objects of the model, and may include information regarding interactions of objects in the model. The configuration of the model may be used by a simulation system of the interactive assignment system to simulate the problem based on the model and determine information regarding the model and/or the problem. For example, the simulation system may use the configuration of the model to render one or more images based on the model for presentation via a graphical user interface. The simulation system may additionally or alternatively use the configuration of the model to simulate the interaction of one or more objects of the model to determine an effect of the interaction on one or more properties of the model.

The information stored in data store 102A may additionally or alternatively include data regarding students with which the interactive assignment system may interact. The data regarding a student may include information regarding which problems are to be presented to a student, such as an identification of one or more courses in which a student is enrolled and for which the student is to complete assignments. The data regarding a student may include information regarding the student's interactions with the system regarding a problem. Data regarding the student's interaction may include input provided by a student, whether the input was determined by the system to be correct or incorrect, and a grade assigned to the students work on a problem. Additionally, in embodiments in which an interactive assignment system evaluates the student's input for signs of a common mistake, data stored in data store 102A may include an identification of any common mistakes detected in the student's input.

The interactive assignment system executing on the computing device 102 may produce a configuration of a problem in any suitable manner based on any suitable input. In some embodiments, the interactive assignment system may configure a problem based at least in part on input received from an instructor of a course in an educational environment. The instructor may provide input regarding problems that are to be solved by students of the course. In some embodiments, the instructor may provide the input to the interactive assignment system by providing the input directly to the computing device 102 on which the interactive assignment system is executing. In other embodiments, such as the embodiment illustrated in FIG. 1, the instructor may operate a second computing device 104 located remote from the computing device 102 on which the interactive assignment system is executing. The computing devices 102, 104 may communicate with one another via a computer communication network 106. The network 106 may be any suitable one or more wired and/or wireless networks, including a local area network (LAN) and/or the Internet. In some embodiments, a graphical user interface of the interactive assignment system may be presented to the instructor on the computing device 104 and the instructor may provide input regarding a problem to the computing device 104. The input from the instructor may then be communicated via the network 106 from the computing device 104 to the computing device 102 and used by the interactive assignment system to configure a problem. Once the interactive assignment system configures the problem based on the input, the interactive assignment system may store the configuration of the problem in the data store 102A.

The interactive assignment system may use the configurations of the problems to present problems to students to be solved. The interaction assignment system may present problems to students for solution in any suitable manner. In some embodiments, a student may access the interactive assignment system by directly interacting with the computing device 102, such as by operating a user interface of the computing device 102. In other embodiments, a student may operate a computing device 108 that is remote from the computing device 102 to interact with the interactive assignment system and provide input regarding problems. For example, a student may operate a computing device 108 that can communication with the computing device 102 via the network 106 and a graphical user interface of the interactive assignment system may be presented to the user via the computing device 108. The interactive assignment system may display information regarding a problem to the student via the interface and receive from a student, via the interface, information regarding the problem. For example, the interactive assignment system may present, via a graphical user interface, a rendering of a model of the problem, a description of a desired solution, and a prompt for the desired solution.

When the student views the problem via the interface, the student may provide input to the interactive assignment system regarding the problem, such as input regarding one or more properties of the model. As discussed above, in some embodiments, a student may be able to provide input regarding a number of different properties of a model, including properties of the model that are not related to the desired solution. The input that the user may provide via the graphical user interface may include characterizations of properties of the model of the problem. The characterizations may include a numeric value and/or an expression describing a property of the model, or any other suitable characterization.

In response to receiving input from a student, the computing device 108 may transmit information regarding the student's input to the computing device 102, where the input may be processed by the interactive assignment system. The interactive assignment system 102 may process the input in any suitable manner. In some embodiments, the interactive assignment system may determine whether the input provided by a student is correct. For example, when a student inputs a characterization of a property of the model, the interactive assignment system may determine information regarding the property of the model and present information regarding the property to the student. The information regarding the property that may be determined by the interactive assignment system may include a correct characterization of the property. The interactive assignment system may evaluate the student's input characterization based at least in part on the information about the property determined by the system, such as by comparing the student's input characterization to the correct characterization. Based on the evaluation, the interactive assignment system may present information to the student regarding the property. For example, the interactive assignment system may present information to the student identifying the student's input characterization as correct or incorrect.

In some embodiments, the interactive assignment system may interact with multiple different students and present problems to each of the multiple different students. In some such embodiments, each of the multiple different students may operate a different computing device to interact with the interactive assignment system. For example, as illustrated in FIG. 1, students may operate computing devices 108, 108A, and 108B to view problems and provide input regarding problems.

It should be appreciated that embodiments are not limited to operating with any particular type of computing device or computing devices and that embodiments may operate with any particular type of computing device. Computing devices with which embodiments may operate include servers, desktop or laptop personal computers, tablet computers, and mobile phones. For example, in some embodiments, computing device 102 may be implemented as a server, computing device 104 may be implemented as a desktop personal computer, and computing devices 108, 108A, and 108B may be implemented as a laptop personal computer, a tablet computer, and a mobile phone, respectively. Additionally, it should be appreciated that while each of the computing devices illustrated in FIG. 1 is shown as a single device, any or all of the devices may be implemented as a set of two or more computing devices that share computing resources and share processing tasks. For example, computing device 102 may be implemented as a network of servers sharing resources and processing tasks.

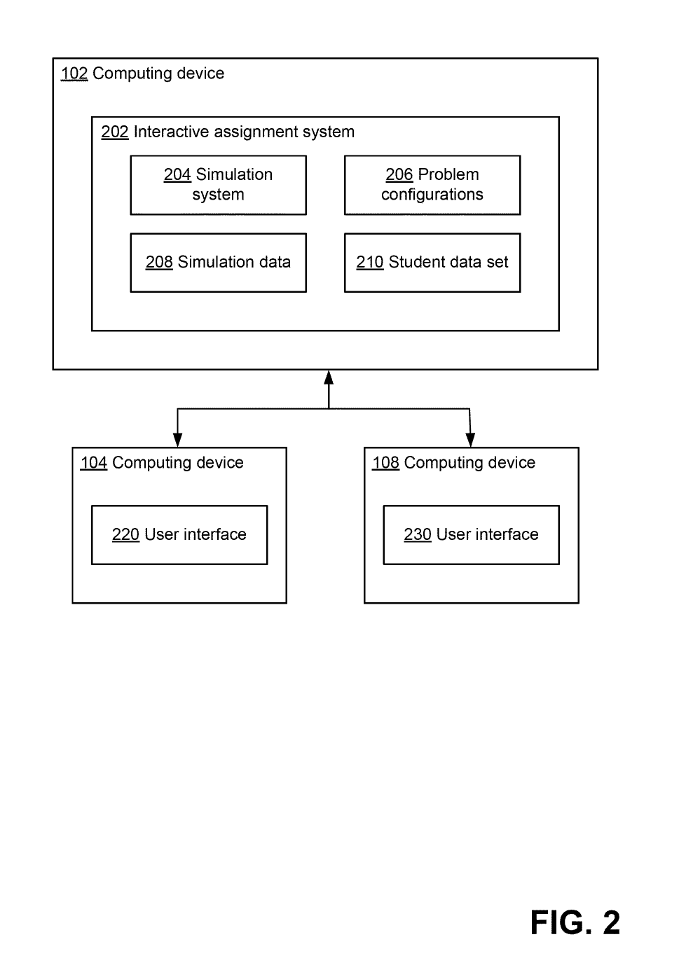

FIG. 2 illustrates components that may be included in an interactive assignment system in some embodiments. More particularly, the block diagram of FIG. 2 shows components of the interactive assignment system 202 that may be implemented in some of the computing devices illustrated in the computer system 100 of FIG. 1. The interactive assignment system 202 may execute on the computing device 102 to carry out some or all of the techniques described herein. The interactive assignment system 202 may include a simulation system 204 that may also execute on the computing device 102 to evaluate a model of a problem and simulate interactions of objects of the model. Examples of operations that may be carried out by the simulation system 204 are described in detail below.

The interactive assignment system 202 may also include data to be processed by the system 202 or resulting from processing performed by the system 202, such as data stored in a data store 102A of FIG. 1. The data may include configurations of one or more problems 206 that may be used to present problems to students and a data store 210 of information about the students. The information on the students 210 may, in a case in which the interactive assignment system 202 is used with multiple courses, include information on which students are included in which courses, which may be used by the interactive assignment system 202 to determine which problems to present to which students. The information on the students 210 may also include information on input provided by the students, such as inputs provided by the students that the interactive assignment system has determined to be correct or incorrect and grades assigned by the interactive assignment system 202 to the students' work. By logging input provided by the students in the data set 210, the interactive assignment system 202 may be able to provide information to an instructor on how one or more students is progressing. For example, if a student asks the instructor for assistance, the instructor may be able to request that the interactive assignment system 202 display to the instructor input provided by that student. From reviewing the student's input to the system 202, the instructor may determine how to better assist the student with the subject of the student's question.

The data of the interactive assignment system 202 may also include simulation data 208. Simulation data 208 may include any suitable information that may be used by the simulation system 204 as part of simulating a problem. Simulating a problem may include evaluating objects included in a model of a problem and interactions of the objects to determine characterizations of one or more properties of the model. Information that may be used by the simulation system 204 may include information defining objects that may be included in models that are to be simulated, such as information defining properties of objects that may be included in simulations and information defining relationships between properties of objects. The information defining relationships between properties of objects may include information identifying relationships between properties of one object and/or information identifying relationships between properties of other objects with which an object may interact. The information defining a relationship may include information regarding the manner in which a property of an object may be affected by other properties of that object or by properties of another object. The manner in which a property of an object may be affected by other properties may be indicated by mathematical expressions that indicate relationships between properties and that can be used to perform calculations involving values of the properties. For example, in some embodiments, a model of a problem may correspond to a physical scenario and objects of the model may correspond to physical objects of the scenario. In such cases, properties of the objects may correspond to physical properties of the physical objects. Physical laws may govern relationships between such physical properties, which may be modeled by mathematical expressions. The simulation data 208 may include mathematical expressions corresponding to these physical laws which may be used by the simulation system 204 to determine an effect of interactions of objects, including determining an effect of one or more properties of a model on another property of a model and determining a characterization of the other property of the model.

The information 208 that may be used by the simulation system 204 as part of simulating a problem may include information on notation used for properties of a model or for characterizations of properties of a model. In some cases, a property of a model may be characterizable using multiple different units, such as different units for an Imperial System of measurement and the International System of measurement. In other cases, one character may characterize different properties when used in different expressions or one property may be characterizable using different characters in different expressions. As a further example, different instructors or different textbooks may use different notation styles for the same property. The simulation data 208 may therefore include information on different characterizations that may be used with the interactive assignment system 202. The different characterizations may be arranged as different sets of characterizations, such as in the case of different units of measure or different notation styles.

As discussed above, in some embodiments, an instructor and a student may interact with the interactive assignment system 202 via computing devices located remote from a computing device on which the interactive assignment system 202 is executing. The computing devices 104, 108 may therefore present user interfaces of the interactive assignment system 202 to the instructor and student, respectively. As illustrated in FIG. 2, the computing device 104 may execute a user interface 220 of the interactive assignment system, which may include displaying graphics of the interactive assignment system 202, accepting input from the instructor via the interface 220, and providing the input (and/or information regarding the input) to the interactive assignment system 202 over one or more computer communication networks. The computing device 106 may similarly execute a user interface 230 and display graphics, accepting input from a student, and provide the input (and/or information regarding the input) to the interactive assignment system 202 over one or more communication networks. The interfaces 220, 230 may be any suitable interfaces, as embodiments are not limited in this respect. In some cases, the interfaces 220, 230 may be web interfaces that are downloaded to the computing devices 104, 108 and rendered via web browsers. Such web interfaces may include any suitable web technology for interacting with a user, including, for example, markup text, Javascript, and Java plugins. In embodiments in which the interfaces 220, 230 are web interfaces, the interface 220 may include one or more web pages that may be used by an instructor to provide input configuring a problem, including configuring a model of a problem. Similarly, in such embodiments, the interface 230 may include one or more web pages that may be used by a student to view problems, provide input regarding problems, and receive feedback from the interactive assignment system 202 regarding the input.

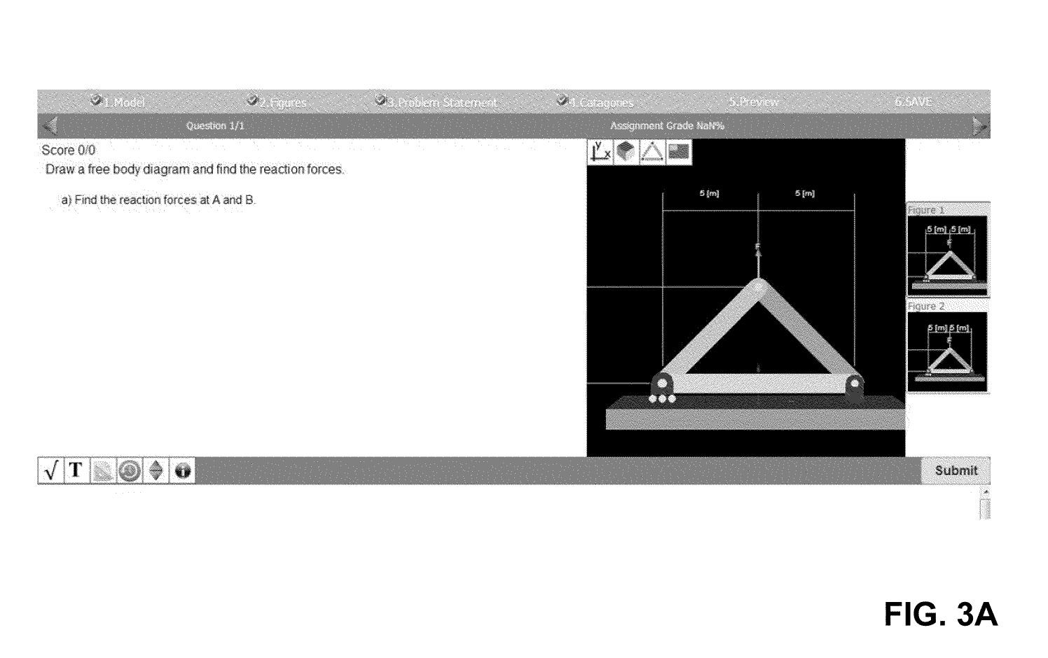

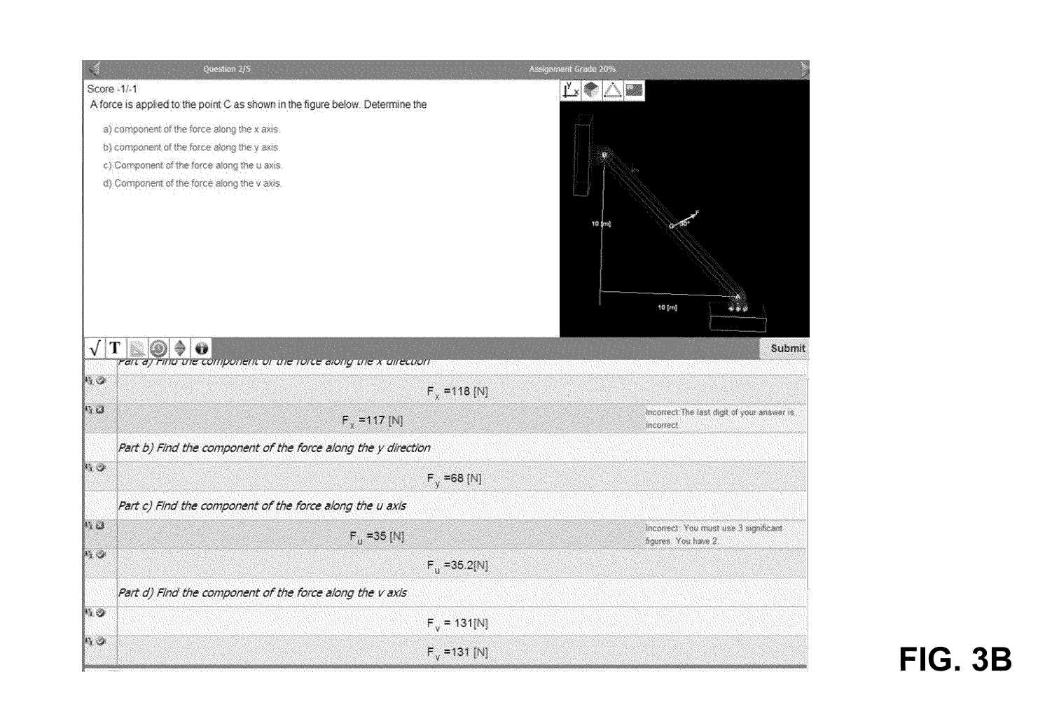

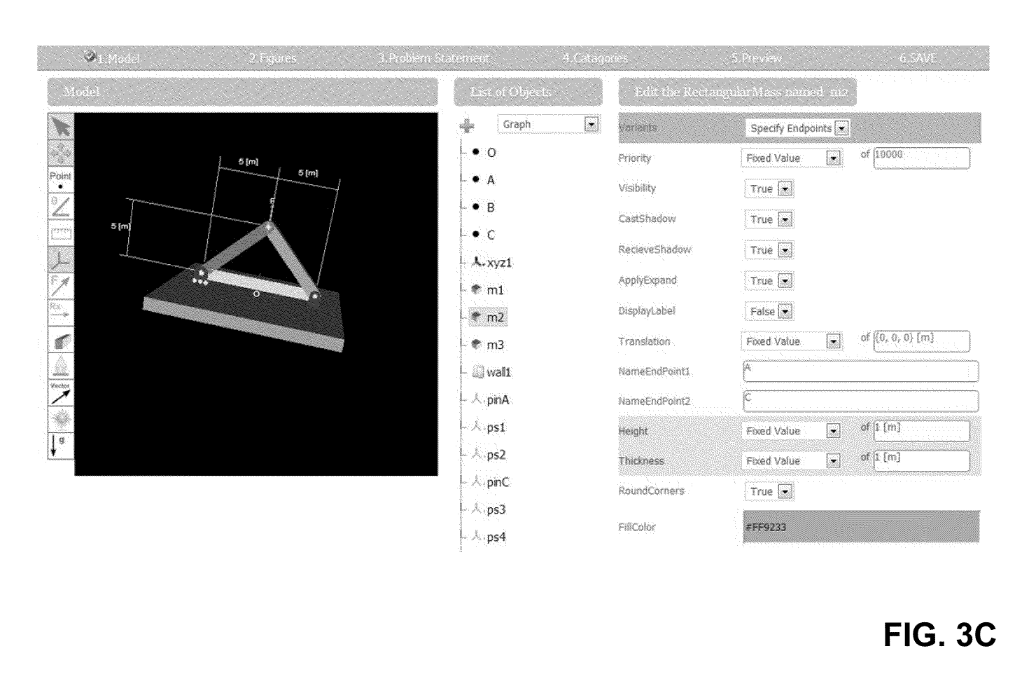

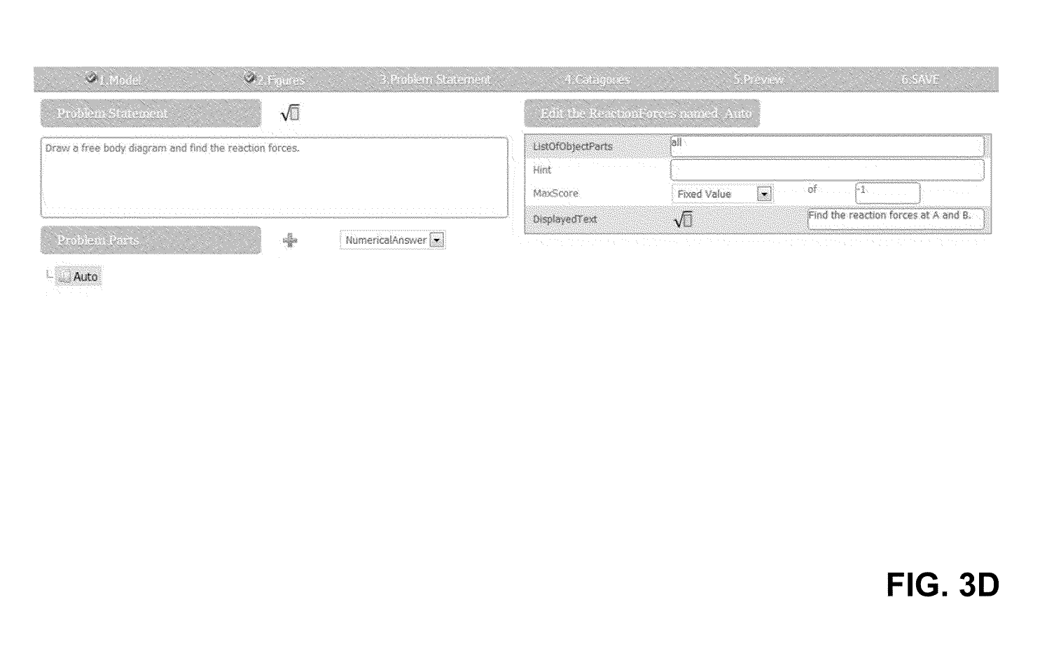

FIGS. 3A-3D illustrate examples of user interfaces that may be implemented in some embodiments to present information to and receive information from instructors and students for an interactive assignment system. FIG. 3A shows an example of a user interface that may be presented to an instructor for providing input to the interactive assignment system that the interactive assignment system will use to configure a problem. The instructor may provide the input in several steps, including by defining a model, defining figures that will be presented to a student which may be different views of the model, defining a problem statement for the problem that includes a prompt that will be presented to a student and a desired solution to the problem, and tagging the problem with one or more categories that can be used to classify the problem in a data store so that the problem can be easily retrieved and reused later. The screenshot of FIG. 3A is a “Preview” window that may be presented to an instructor after the instructor has provided the inputs, showing how the interactive assignment system has configured the problem and how the problem will be presented to a student. As can be seen from the screenshot of FIG. 3A, the problem includes a model of a scenario, which includes multiple objects, including beams, surfaces, pins, hinges, rollers, surfaces, and forces. More particularly, objects of the example of FIG. 3A include multiple beams that are joined by pins and which are connected to an underlying surface by a fixed hinge on a right-hand side and by a moveable roller on the left-hand side. The model also includes and object that is a force pulling upward on an upward joint of the beams. The model illustrates that properties of the model regarding a horizontal distance between a point of interaction of the two upper members and the respective points of interaction of the upper members and the lower members have been set to 5 meters. The screenshot of FIG. 3A also indicates that the problem statement includes a prompt to the user to “draw a free body diagram and find the reaction forces,” including the reaction force at two points specified in the model, A and B. When the problem is approved by the instructor and subsequently presented to a student, the student may therefore use an interface of the interactive assignment system to provide input regarding a model that is a free-body diagram of the model presented in the screenshot of FIG. 3A. The student may also provide as input characterizations of the reaction force at points A and B.

FIG. 3B illustrates an interface that may be presented to a student for interacting with the interactive assignment system regarding a problem and providing input regarding a problem. In the example of FIG. 3B, the student is prompted to provide input regarding components of a force along different axes. The student is presented in the interface with a model illustrating a beam attached to two different surfaces with different types of attachments. The beam is attached to an upper, left-hand surface with a hinge and is attached to a lower, right-hand surface with a roller. The model also includes another object which is a force that interacts with the beam at a point near the middle of the beam to pull the beam outward, away from the upper, left-hand surface. The lower half of the screenshot of FIG. 3B illustrates, in accordance with the prompts of the problem, the student providing input regarding each of the desired solutions to the problem. The screenshot shows the characterizations that have been input by the student as well as feedback from the interactive assignment system indicating whether a student's characterization is correct or incorrect. In the example of FIG. 3B, the feedback is in the form of icons on the left-hand side of the screenshot. The screenshot also illustrates, in the case that the interactive assignment system determines that the student's characterization is incorrect, educational messages presented to the student regarding the student's characterization, such as “The last digit of your answer is incorrect” and “You must use 3 significant digits. You have 2.”

FIG. 3C is a screenshot of an interface that may be presented to an instructor for providing input regarding a model that is to be used in a problem. The model that is illustrated in FIG. 3C corresponds to the model shown in FIG. 3A. The screenshot of FIG. 3C illustrates that the model may be defined using a system similar to a three-dimensional drawing system, such as a computer-assisted drafting (CAD) system. The interface of the interactive assignment system may present to the instructor a listing of objects that may be included in the three-dimensional model and the instructor may select objects to be included in the model from the listing. Once the instructor has selected an object and added the object to the model, the instructor may configure properties of the object, properties of and points of interactions between the object and other objects in the model, and display attributes of the object in the model such as a color of the object and whether the object is to cast a shadow in renderings of the model. Properties of the objects and model that may be set by the instructor in the example of FIG. 3C include distances between points, such as the distances that are illustrated in the model of 5 meters between points of interaction between objects in the model. The model includes a force acting on the point of interaction between the two upper beams and, using the interface of FIG. 3C, the instructor may be able to configure a magnitude and direction of the force, or other suitable property of a force.

FIG. 3D illustrates a screenshot of an interface that may be presented to an instructor for providing input regarding a problem statement and a desired solution to the problem. The problem statement may be a description of the problem and a prompt to a student to provide the desired solution. The problem statement may be displayed to a student when the problem is presented to a student, as illustrated in FIGS. 3A and 3B. The instructor may be able to set a format of a desired solution, which may be a type of characterization that a student is to provide as input. An interactive assignment system may enable an instructor to select any one of one, two, or more types of characterizations to provide as input as a desired solution, including numeric value of a property, units of a property, an expression defining a property, an identification of one of multiple characterizations displayed as options in a multiple choice problem, or a model. In the example of FIG. 3D, the instructor has selected that the student is to provide a numeric value (“NumericalAnswer”). As discussed above, in some embodiments (including the embodiment of the example of FIG. 3D), an instructor may not be required to provide the desired solution, such as the numeric value of the correct answer. Rather, the instructor may instead identify a property to which a desired solution relates, such as a numeric value of the magnitude of the force “Auto” in the model, and the interactive assignment system may determine a correct characterization of the property that is the desired solution. This may reduce a burden on an instructor in defining problems, as the instructor is not required to determine the correct characterization for each problem the instructor creates.

Having discussed examples of components that may be included in embodiments of an interactive assignment system and examples of interfaces that may be used by embodiments of an interactive assignment system, described below are examples of processes that may be carried out by an interactive assignment system in some embodiments.

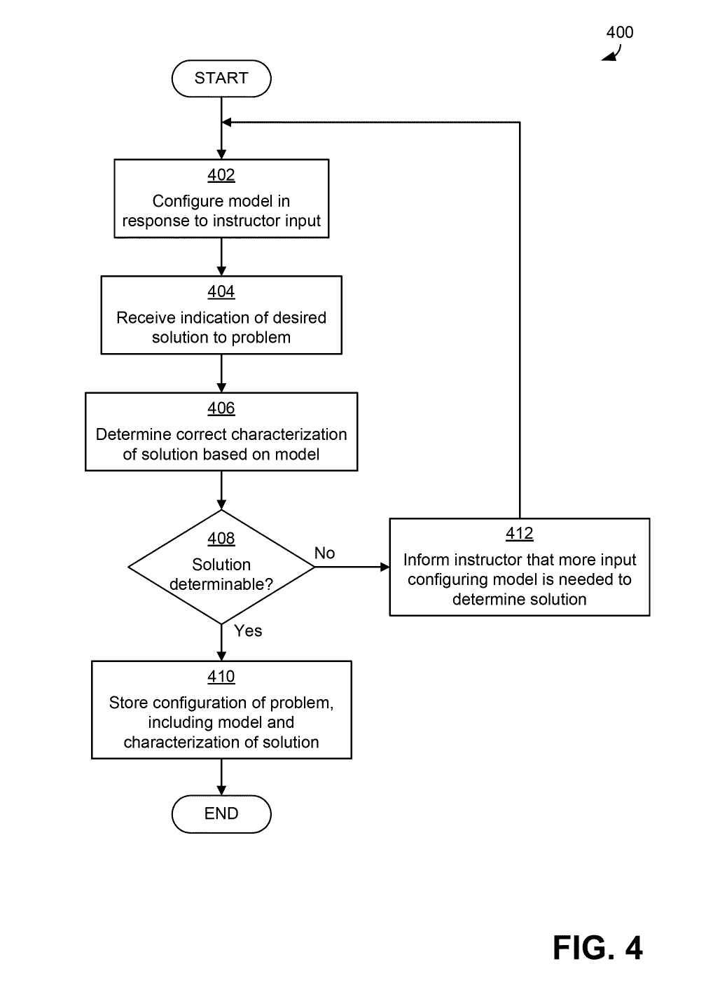

FIG. 4 illustrates an example of a process that may be carried out in some embodiments by an interactive assignment system to configure a problem in response to input provided by an instructor. Prior to the start of the process 400 of FIG. 4, an instructor loads an interface of the interactive assignment system and requests that the interactive assignment system configure a new problem. The interactive assignment system presents multiple options to the instructor regarding the problem, such as via an interface like the ones discussed above in connection with FIGS. 3A, 3C, and 3D. The instructor may then interact with the interface to provide input regarding the problem to be configured.

The process 400 begins in block 402, in which the interactive assignment system configures a model of the problem in response to instructor input regarding model. The input received from the instructor regarding the model may be any suitable information regarding the model. In some cases, for example, the instructor may provide input regarding one or more objects to be included in the model. The interface presented to the instructor by the interactive assignment system may include a listing of objects that may be included in a model, and the interface may detect a selection by the instructor of one or more objects to be included in the model. In some cases, the instructor may additionally provide input regarding properties of objects of the model. Input regarding properties of the model may include input regarding properties of objects of the model, properties of interactions between objects of the model, or other information regarding the model. For example, where an object included in the model includes multiple properties, such as properties that corresponds to physical properties of a physical object that the object of the model is to simulate, the instructor may provide input regarding one or more of the properties. For example, the instructor may provide input that is a numeric value of one or more of the properties or that is some other characterization of a property.

The interactive assignment system may receive any suitable information regarding any suitable property of a model, including any suitable property of an object of a model, as embodiments are not limited to operating with any particular properties or any particular objects. Properties of a model may include any suitable information that may affect a property of an object. A property of an object may be any suitable information that may affect how an object of a model interacts with other objects of a model, including how the object affects one or more properties of one or more other objects or is affected by one or more properties of one or more other objects. Thus, a property of a model may, in some cases, be a value that may form a part of a calculation performed by a simulation system to determine a numeric value of a property or otherwise form a part of an expression evaluated by a simulation system to determine a characterization of a property. In some cases, a property of an object may correspond to a physical property of a physical object. Properties of an object for which input may be received from an instructor may include properties such as a mass of an object, a length of an object, an internal stress of an object, a resistivity or resistance of an object, a voltage and/or current output by an object, a temperature of an object, or any other suitable information regarding an object. Properties of a model may also not directly relate to an object in the model, but may relate to properties of an environment of the objects, such as an environment of a scenario to which the model relates. For example, information regarding a pressure of an environment, temperature of an environment, gravitational force of an environment, or other environmental properties may be set as properties of a model.

Accordingly, in block 402, in response to input from an instructor regarding a model, such as input regarding objects and/or properties of a model, the interactive assignment system configures a model of the problem. Configuring the model may include storing information in a storage medium regarding the model. Storing information regarding the model may include storing information regarding objects and/or properties of the model that may be used by a simulation system to perform operations regarding the model and that may be used to render a visualization of the model. Operations regarding the model that may be performed by the simulation system include determining characterizations of one or more properties of the model.

In block 404, the interactive assignment system receives from the instructor an indication of a desired solution to the problem. The indication of the desired solution that is received in block 404 may be any suitable indication, as embodiments are not limited in this respect. For example, the indication may include an identification of one or more properties to which the desired solution may relate, such as properties of a model, including properties of one or more objects of the model. A property to which a desired solution relates may be a property for which a student is to input a characterization. The characterization that the student is to input may be a characterization defining or describing the property, such as a numeric value of the property and/or an expression describing values of the property. Additionally, the indication of is received in block 404 may include an indication of a desired format of a characterization that is to be received from a student as a solution to the problem. For example, indication may identify whether the student is to provide a numeric value, an expression, or some other characterization of a property.

In block 406, the interactive assignment system may determine, or attempt to determine, a correct characterization of a solution based on the model that was configured in block 402. The correct characterization may be determined by evaluating the model using a simulation system of the interactive assignment system to determine a characterization of the property to which the desired solution relates. To determine the characterization, the simulation system may perform any suitable processing on the model that was configured by the interactive assignment system in block 402. For example, the interactive assignment system may perform processing on one or more properties of the model to determine an effect of these properties of the model on one or more other properties of the model, including the property to which the desired solution relates. For example, the simulation system may perform a calculation on numeric values of one or more properties to determine a numeric value of the property to which the desired solution relates. As another example, the simulation system may evaluate one or more expressions defining one or more properties of the model to determine an expression defining the property to which the desired solution relates. The correct characterization that the interactive assignment system determines, or attempts to determine, in block 406 may be a characterization in a format indicated by the indication of the desired solution received in block 404, in a case that the instructor provides an indication of a desired format.

In some cases, interactive assignment system may, while attempting to determine a correct characterization of a property to which the desired solution relates, determine that the characterization is not determinable using the information provided by the instructor. For example, instructor may have provided input defining a model, but not have provided sufficient information regarding the model for the simulation system to determine a characterization of a property to which the desired solution relates. This may be the case when an instructor indicates that a desired solution is a numeric value of a property and a numeric value of that property depends on a calculation involving a numeric value of another property of the model. If the instructor did not provide a numeric value of that other property, or the numeric value is not determinable from calculations involving numeric values that were provided by instructor, or the simulation system does not include a default numeric value for that property, the simulation system may not be able to determine a numeric value for the property to which the desired solution relates.

Accordingly, in block 408, the interactive assignment system may determine whether the solution that the system attempted to determine in block 406 is determinable. If not, the interactive assignment system, in block 412, presents a message to the instructor indicating that more input regarding the model is needed to determine the solution desired by the instructor. Once the interactive assignment system presents the message in block 412, the process 400 continues to block 402, in which the interactive assignment system receives further input regarding the model from the instructor and configures the model in response the input.

If, however, the interactive assignment system determines in block 408 that the solution was determinable (and was thus determined in block 406), then the interactive assignment system may store a configuration of the problem that the interactive assignment system has created through the process 400 of FIG. 4. In particular, the interactive assignment system may store as part of the configuration of the problem a configuration of the model, an indication of the desired solution to the problem, and a correct characterization of the solution. The configuration may be stored in any suitable manner, including in any suitable data store accessible to a computing device on which the interactive assignment system executes.

Following the storage of the configuration of the problem in block 410, the process 400 ends. Following the process 400, a storage medium stores a configuration of a problem for the interactive assignment system. The interactive assignment system may use the configuration of the problem that is stored to present a problem to a student. As discussed in greater detail below, the interactive assignment system may retrieve the configuration of the problem from the storage medium and present to the problem to a student via a user interface. For example, the model that was configured by the interactive assignment system in block 402 may be presented to a student and used by a simulation system to evaluate input received from a student.

The operations of block 410 were discussed above as including storing, as a part of a configuration of a problem, a correct characterization of a property to which the desired solution relates. It should be appreciated, however, that embodiments are not limited to storing a correct characterization of a property as part of a configuration of a problem. Rather, in some embodiments, the interactive assignment system may store an indication of the desired solution and, when the problem is presented to a student at a later time, determine the correct characterization of a property to which the desired solution relates. Embodiments are not limited to determining a correct characterization of a property to which a desired solution relates in any particular manner or at any particular time.

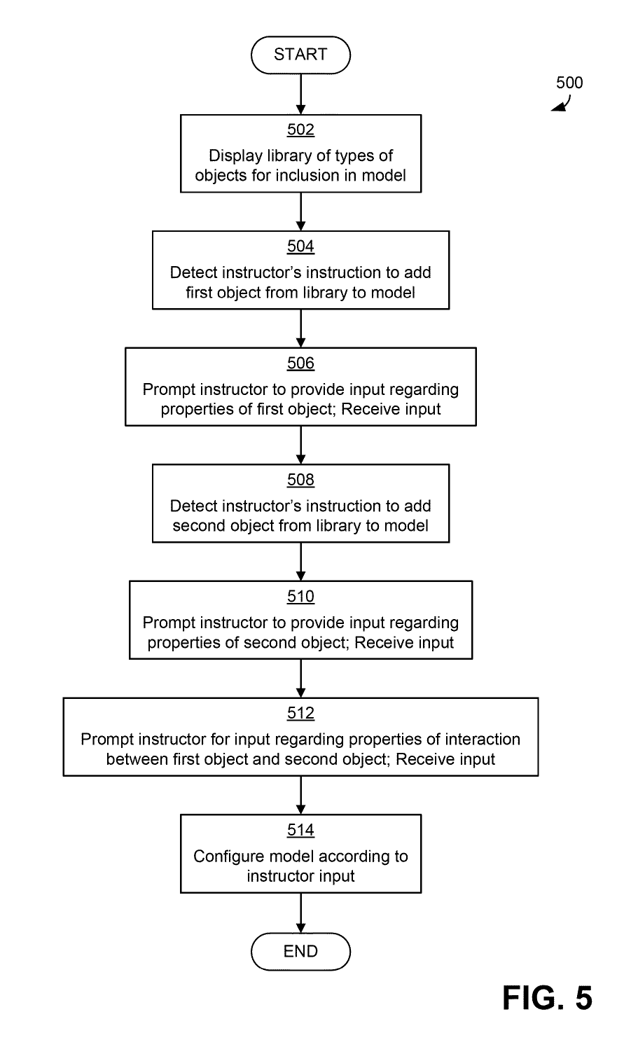

The configuring of a model by the interactive assignment system was described briefly above in connection with block 402 of FIG. 4. FIG. 5 illustrates an example of a process 500 that may be implemented by an interactive assignment system in some embodiments for configuring a model in response to input from an instructor.

Prior to the process 500 of FIG. 5, an instructor loads an interface of the interactive assignment system and requests that the interactive assignment system configure a problem in response to input from the instructor. The process 500 begins in block 502, in which the interactive assignment system displays to the instructor, via an interface of the interactive assignment system, a library types of objects that are available for inclusion in model. The library of types of objects that is displayed to the instructor in block 502 may be organized in any suitable manner. In some embodiments, the library may be organized according to different categories of scenarios in which objects may be included. For example, the library may be organized according to different types of physical scenarios that may be simulated, which may correspond to different types of courses in an educational environment. For example, the library may be organized into different sets of types of objects that correspond to different courses, such as a set of types of objects that may be included in a model for an engineering statics or dynamics course, such as beams, pins, and forces, and a set of types of objects that may be included in an electric circuits course, such as resistors, electric fields, and voltage sources. In some embodiments, an instructor may be prompted to provide input regarding a category of scenario that the model is to simulate. In such embodiments, once the instructor has provided input regarding the scenario category, the interactive assignment system may display in block 502 a set of objects that are categorized according to the category indicated by the instructor. It should be appreciated, however, that embodiments are not limited to categorizing types of objects of the library according to scenario categories or excepting input from an instructor regarding a category of scenario that the model is to simulate.

In block 504, after the interactive assignment system displays the library types of objects in block 502, the interactive assignment system detects that the instructor has selected one of the types of objects and indicated that an object of that type is to be added to the model. In response to the instructor's selection, the interactive assignment system may determine from the instructor a location at which the object is to appear in the model. The selection and the location may be received from the instructor in any suitable manner, including, in some embodiments, by detecting that a user has clicked on an icon for a type of object in a displayed listing of objects, drag the icon to a particular location in the model, and released the icon. Such a “drag and drop” operation may indicate both the user selection and a location at which the object is to be placed in the model.

In block 506, once the object of the type indicated by the instructor has been added to the model, the interactive assignment system may prompt the instructor to input one or more properties of the object. In response to the prompt, the instructor may provide a characterization of one or more properties of the object that was added in block 504. For example, the instructor may provide a numeric value of one or more properties of the object. To prompt the instructor to provide input regarding one or more properties of the model, the interactive assignment system may display to the instructor an interface that lists multiple properties of the object that was added in block 504. In such an interface, the interactive assignment system may display each of the properties together with a prompt for the instructor to enter input regarding the property. For example, the interface may include an identification of a property together with a text box for the instructor to provide a numeric value or other characterization of the property. Once the interactive assignment system prompts the instructor to provide the input, in block 506, the interactive assignment system receives from the instructor input regarding one or more properties of the object.

In block 508, the interactive assignment system detects a selection by the instructor of a second object from the library that is to be added to the model, and, in block 510, prompts the instructor to provide input regarding one or more properties of the object and receives input from the instructor regarding those properties. The interactive assignment system may carry out the operations of blocks 508 and 510 in a manner substantially similar to the operations of blocks 504 and 506 discussed above.

Once the first and second objects have been added to the model by the interactive assignment system in response to the instructor's input, the interactive assignment system may configure properties of an interaction between the two objects in block 512. The interactive assignment system may configure the properties of the interaction in response to input received from the instructor.

In some embodiments, properties of the interaction of the two objects may include determining a location of an interaction between the two objects. A location of an interaction between two objects may define a manner in which one object affects another. For example, a location of an interaction may impact properties of an interaction. In an engineering statics environment, for example, a location of a junction of one beam and another beam may affect a torque that one beam imposes on another. As another example, in an electric circuits problem, a voltage source that is connected to a gate terminal of a MOS transistor may affect the transistor differently than if the voltage source were connected to a source terminal of the MOS transistor. Thus, the instructor may, in block 512, provide input regarding a location of an interaction between the first and second object, and the interactive assignment system may configure the model in response to the instructor input.

In some embodiments, properties of the interaction of the two objects may include defining a type of an interaction between two objects. The type of interaction may determine how one object affects another object in the simulation. For example, a type of interaction may include a manner in which one object is connected to another in the model. A manner in which one object is connected to another may, in some cases, include a type of object that connects the objects. The type of a third object that connects two objects may affect the manner in which objects interact. For example, in an engineering statics model, two beams may be connected in multiple different ways that affect the interactions between the objects. A beam may be connected to another beam by a moveable pin like a hinge or may be connected to another beam by a fixed, immovable point, or may be connected in some other manner. If the beams are connected by a hinge or other moveable object, the beams to move relative to one another, whereas if the beams are connected via a fixed point they may not move relative to one another. Whether or not the beams may move relative to one another may impact a way in which one beam affects another in the simulation, such as by affecting a manner in which one beam exerts a force on another. The simulation system of the interactive assignment system may account for a type of interaction between objects when simulating an interaction of the objects and determining a characterization of a property of the model. Therefore, the interactive assignment system may configure the model with information regarding the type of interaction between two objects in block 512.

In blocks 506, 510, and 512 described above, the interactive assignment system configures a model in response to input from the instructor regarding one or more properties of the model, including properties of objects of the model. In the specific examples described above, the instructor input characterizations of properties, such as numeric values of the properties. It should be appreciated, however, that the interactive assignment system is not limited to accepting input from an instructor in block 506, 510, and 512 of characterizations of properties of the model. In some embodiments, the interactive assignment system may be configured to randomly generate one or more properties of a model (which may include pseudo-randomly generating a property). For example, an interactive assignment system may randomly generate a characterization of a property, such as a value of a mass for an object or a location that a force acts on a beam. Accordingly, in configuring a model, the interactive assignment system may, in some embodiments, configure the model so that a property of a model is randomly generated during simulation of the model.

The interactive assignment system may configure a model such that one or more properties of the model are randomly generated in response to input from an instructor. The input from the instructor may identify a property and identify that the property should be randomly generated. For example, the input may identify that a characterization of a property, such as a numeric value or an expression describing the property, should be randomly generated. The input from the instructor identifying that the property is to be randomly generated may be in any suitable form and may impose any suitable restrictions on the random generation of the property. In some cases, a property may have a finite set of potential values and input from an instructor may identify that the input is to take any value from the finite set of potential values. For example, a beam may have a limited number of locations at which a force may act on the beam, which is locations along a length of the beam. Accordingly, if a location of interaction between a force and a beam is to be randomly generated by the interactive assignment system, the location will be randomly generated as one of the finite set of potential values. As another example, in a physics scenario, a point charge that creates an electric field may have a finite number of locations at which it may be positioned in a model, as the model may have a limited coordinate system in which objects may be positioned. Accordingly, if the position of the point charge is a property of the point charge that is to be randomly generated, the position will be randomly selected from the finite set of coordinates in the coordinate system. In other cases, however, a property may not have a finite set of potential values, such as in the case of a property that may be able to take any positive number value. The interactive assignment system may therefore be able to accept input from a user imposing one or more limitations on a random generation of a property. The limitations may be received for a property that has either a finite set of potential values or an infinite set of potential values. For example, an instructor may provide input indicating that a location of an interaction between a force and a beam is to be randomly generated at a location between 5 and 6 meters from an end of a beam. As another example, an instructor may provide input indicating that a numeric value for a mass of an object is to be randomly selected between 10 and 20 kilograms. The limitations input by an instructor may not define a finite set of potential values in all cases. For example, an instructor may input a limitation indicating that a numeric value of a mass is to be randomly selected as a value greater than 10 kilograms.

The input regarding the limitation(s) may be received from the instructor in any suitable format, as embodiments are not limited in this respect. In some embodiments, an interface displayed to the instructor that prompts the instructor for information regarding properties, such as the interface discussed above in connection with block 506, may include an option for an instructor to indicate that a property is to be randomly selected. When the instructor indicates that a property is to be randomly selected, the interface may prompt the instructor with the option to enter one or more limitations on the random generation. In response to receiving input from the instructor regarding random generation of properties and/or limitations on random generation, the interactive assignment system may configure the model with information regarding the random selection, such as the limitations on the random selection input by the instructor.

Once the input regarding the objects, properties, and interactions has been accepted from an instructor and processed by the interactive assignment system in blocks 504-512, in block 514 the interactive assignment system may configure a model of the problem. Configuring the model may include storing information regarding the objects of the model and the properties of the model such that the configuration can be later retrieved and used to present a problem to a student. A configuration of a problem may be stored in any suitable manner, as embodiments are not limited in this respect.

Once the configuration of the model is stored in block 514, the process 500 ends. Following the process 500, a model of a problem is configured and stored by the interactive assignment system. Together with information regarding a desired solution to a problem, the interactive assignment system may use the configuration of the model to present a problem to a student.

In some embodiments, following configuration of a problem by an interactive assignment system in response to input from an instructor, the interactive assignment system may process the problem to determine characterizations of one or more properties of the model of the problem. The interactive assignment system may do so to test the model of the problem to determine whether there are any potential errors in the model or missing information that would prevent determination of characterizations of one or more properties. Alternatively, the interactive assignment system may do so to cache the characterizations of one or more properties for later use by the interactive assignment system. By caching the characterizations of the properties, the system is able to retrieve the characterizations for later use without needing to generate the characterizations at the time the characterizations are needed. This may be beneficial in situations in which the interactive assignment system is presenting a problem to multiple different students and interacting with each of the students regarding the model. If the interactive assignment system were to determine a characterization of a property each time the characterization is needed for an interaction with each student, with multiple students the system may expend a great deal of processing resources determining characterizations. Accordingly, by determining some characterizations in advance, at the time the model is configured by the interactive assignment system, and caching the characterizations for later use, the system may be able to save processing resources. This may particularly be the case when the properties for which characterizations are determined and cached in advance are characterizations of properties for which students often request characterizations.

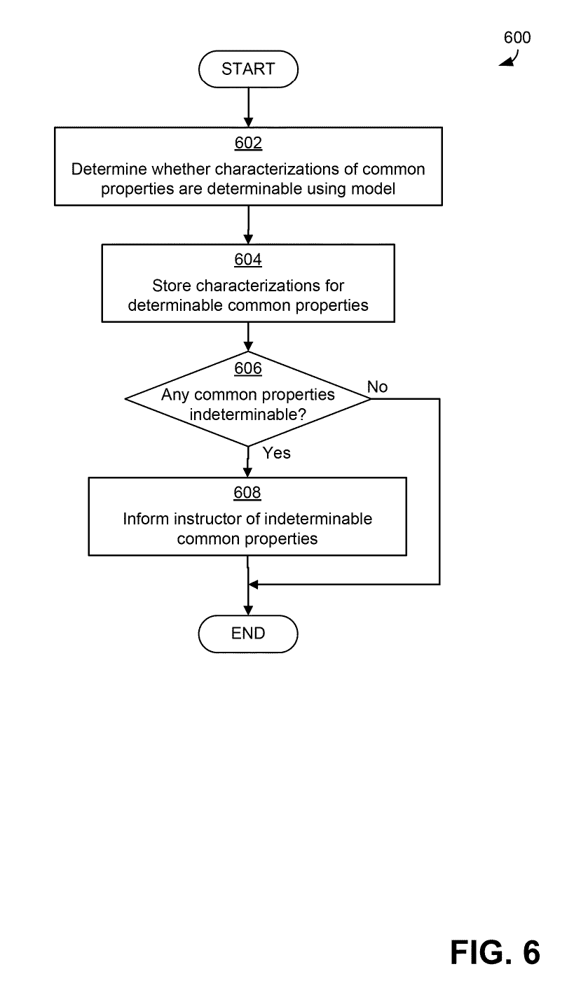

Accordingly, in some embodiments the interactive assignment system may carry out a process for determining characterizations of one or more properties of a model in response to the system configuring a model based on input from an instructor. FIG. 6 illustrates an example of such a process. Prior to the process 600 of FIG. 6, the interactive assignment system receives input from an instructor regarding a model and configures a model in response to the input. The system may, in some cases, additionally receive an indication of a desired solution and determine a characterization of a property to which a desired solution relates. The process 600 may then be carried out by the interactive assignment system to determine characterizations of one or more properties of the model.

The process 600 begins in block 602, in which the interactive assignment system determines whether characterizations of one or more common properties are determinable using a model of a problem. To determine whether the characterizations are determinable, the interactive assignment system may attempt to determine the characterizations and thereby determine a characterization in the case that the characterization is determinable.

The common properties for which the interactive assignment system determines characterizations in block 602 may be any suitable set of properties of the model. The common properties may, in some cases, be common because they are properties for which characterizations are regularly or often determined or that the interactive assignment system determines may be determined during a simulation using the model. In some embodiments, as discussed above, in connection with FIG. 5, a model may be categorized as being associated with a particular category of scenario, which may correspond to a course of study in an educational environment. In some such embodiments, each scenario category may be associated with a set of common properties. For example, in an engineering statics problem, a set of common properties may include tensions, stresses, and moments of each of the beams in the model. As another example, for an electric circuits problem, a set of common properties may include voltages and currents entering and exiting each wire intersection in a model. Accordingly, the set of common properties for which the interactive assignment system attempts to determine characterizations may be determined at least in part by a category of a scenario to which the model relates.

The interactive assignment system may determine the characterizations of the one or more common properties in any suitable manner. A simulation system may evaluate a configuration of a model, including characterizations of one or more properties of a model input by the instructor, as well as information regarding relationships between properties. Information regarding relationships between properties may include one or more functions that the simulation system may use to calculate an effect of one property on a numeric value of another or to derive an expression that describes a property. The interactive assignment system may use the simulation system to determine characterizations of the one or more common properties.

In block 604, the interactive assignment system stores in a data store a characterization of each common property for which a characterization was determinable and determined in block 602. The characterizations may be stored in any suitable manner, including by storing an indication of a property to which the characterizations relate in a structure that maps properties to characterizations.

In block 606, the interactive assignment system determines whether the system could not determine characterizations for any of the common properties. If not (if the system determined characterizations for all properties), then the process 600 ends. If, however, the interactive assignment system determines that the system could not generate characterizations for one or more common properties, then in block 608 the system may inform the instructor of the common properties for which the system could not generate characterizations. The system may inform the instructor in any suitable manner, including by presenting the instructor with a message in an interface that indicates that characterizations of common properties were not determinable or providing the instructor with an identification of properties for which characterizations were not determinable. In some embodiments, the system may additionally inform the instructor via the interface of a reason why a common property was not determinable. For example, the system may identify to the instructor a value that was not supplied by the instructor or any other information that, if provided by the instructor, would make the common property determinable.

Following the presentation of the message to the instructor, or if the system determines that all common properties were determinable, the process 600 ends. Following the process 600, the interactive assignment system has stored a set of characterizations of common properties of a model of a problem. The system may store the characterizations as part of a configuration of a problem such that the characterizations may subsequently be retrieved when a problem is presented to a student. The stored characterizations may then be used to determine whether an input characterization provided by a student is correct without the system needing to generate a characterization of the property at that time.

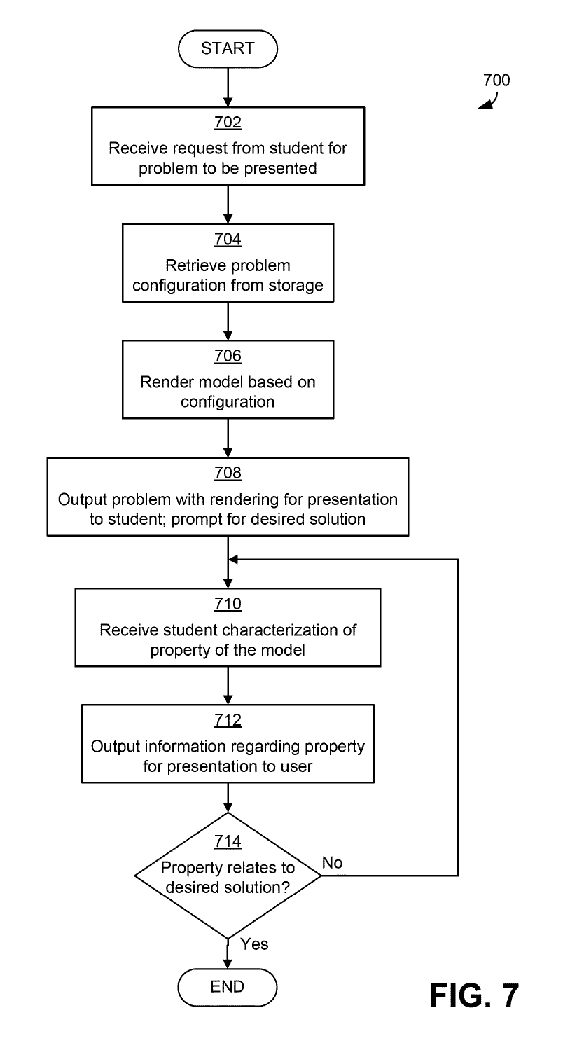

Once a problem has been configured by the interactive assignment system in response to input from an instructor regarding the problem, a problem is available to be presented to a student. FIG. 7 illustrates an example of a process that may be carried out by an interactive assignment system to present a problem to a student for solution by the student. Prior to the start of the process 700 of FIG. 7, a problem configuration is created and stored by the interactive assignment system. Additionally, prior to the start of the process 700, a student loads an interface of the interactive assignment system by which the student can view problems and provide input regarding problems.

The process 700 begins in block 702, in which the interactive assignment system receives from a student, via the interface, a request that a problem be presented. The request may identify the problem to be presented, such as by including an identifier for a problem. Alternatively, the request may not identify the problem, but instead may include a request for a problem and the interactive assignment system may determine the problem to be presented to a student. In such a case, the interactive assignment system may determine from information regarding a student, such as a course in which the student is enrolled, which problem is to be presented to the student.

Once the request is received and a problem identified, in block 704 the interactive assignment system retrieves a configuration of the problem from a storage. As discussed above, the configuration of the problem may include a configuration of a model of the problem and a description of a desired solution to the problem, among any other suitable information. In block 706, based on the configuration of the model, the interactive assignment system may render the model and output the rendering of the model for display to the student in an interface. Rendering the model may include storing any suitable information that can be used to display a graphic of the model via a graphical user interface. In some embodiments, the rendering may be an image of the model that can be displayed to the student so the student can view the model. In some cases, the rendering may be an image with which the student can interact, such as a rendering that enables the student to move a three-dimensional rendering of the model to zoom in/out or rotate the model when the image is displayed in an interface with tools to enable such interaction. In some embodiments, a rendering may have been previously created and stored by the interactive assignment system as part of the configuration of a problem, such as in an embodiment in which an instructor selects images of a model that are to be presented to a student for a problem. In such embodiments, rendering the model in block 706 may include retrieving the stored rendering.

In block 708, the interactive assignment systems outputs the problem for presentation to the student via the interface loaded by the student. As part of outputting the problem for presentation to the student, the interactive assignment system may output the rendering to be displayed to the student and output a prompt for the student to input a characterization. The characterization for which the student is prompted may be a characterization of a property to which a desired solution relates, which is indicated by the configuration of the problem retrieved in block 704.

In block 710, the interactive assignment system receives a characterization of a property of a model. The characterization may be in any suitable format, including the examples of characterizations described above. For example, the characterization received from the student may include an identification of a property, a numeric value of the property, and units for the numeric value (e.g., “F=5 N”). As another example, the characterization received from the student may include an identification of the property and an expression describing the property, which may be an equation defining the property (e.g., “F=m*a”). Where the input received from a student includes an identification of a property, the property may not be separately identified in the input, but may be included in or otherwise implicit in the input. For example, in the case that an input is an expression, the property may be identified by a variable included in the expression, such as the “F” or the “a” in the expression “F=m*a” above.

In some embodiments, the property to which the characterization relates may not be a property to which the desired solution relates. Rather, the student may enter a characterization of any suitable property of the model, including any suitable property of an object of the model. Thus, while the interactive assignment system prompts the student in block 708 for a characterization of one property, the student may enter a characterization of another property in block 710.

The interactive assignment system, in response to receiving the characterization in block 710, may then in block 712 output for presentation to the student information regarding the property. More particularly, in block 712, the system may interact with the student regarding the characterization and the property to which the student's characterization relates. For example, the interactive assignment system may determine a correct characterization of the property to which the student's characterization relates and compare the correct characterization to the student's characterization. Based on the comparison, the system may determine whether the student's input characterization was correct. The interactive assignment system may then present information to the student regarding whether the student's input was correct or incorrect. If the student's input was determined to be incorrect, the system may also in some cases present an educational message to the student regarding the incorrect answer, which the student may be able to use to determine the correct answer.

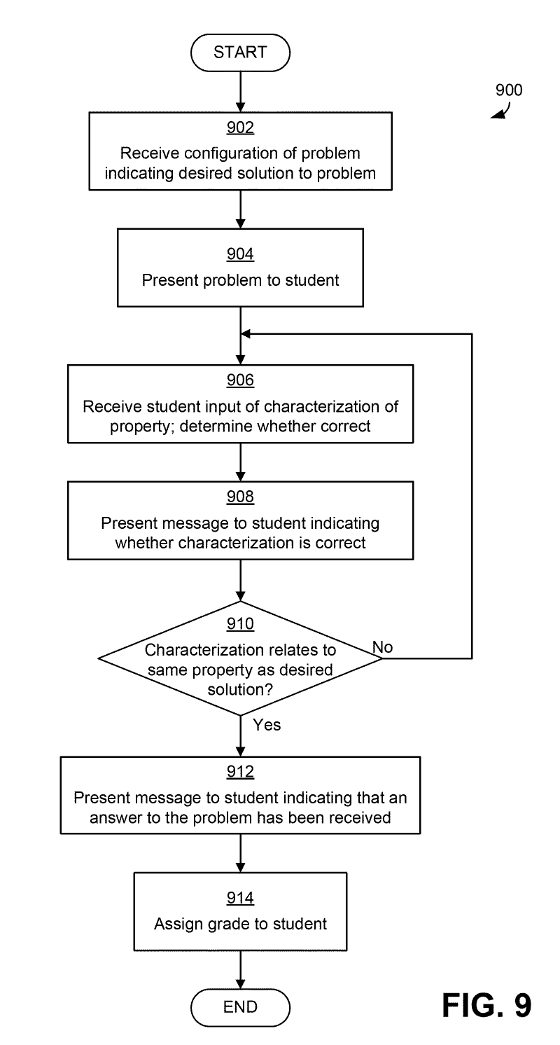

Examples of ways in which the interactive assignment system may evaluate input from a student and present information regarding a property to a student are described in greater detail below in connection with FIGS. 9-16.

Once the interactive assignment system presents information to the student regarding the property to which the student's input characterization relates, the interactive assignment system determines in block 714 whether the property also relates to the desired solution. The system may therefore determine whether the student has provided a solution to the problem by providing the characterization for which the student was prompted. If so, then the process 700 ends. If, however, the interactive assignment system determines in block 714 that the student has provided a characterization of a different property, then the process 700 returns to block 710, in which the system receives a characterization of another property from the student. The interactive assignment system may therefore continue interacting with the student regarding the problem until the student provides a solution to the problem, after which the process 700 ends.

During the process 700, the interactive assignment system may store information regarding the student's interaction with the problem, such as information regarding input provided by the student in block 710 and information presented to the student by the system in block 712. Thus, as a result of the process 700, the interactive assignment system may store information regarding the student's interaction with the problem, including a log of correct and/or incorrect input provided by the student. Such information may be subsequently presented by the system to an instructor for the instructor to determine whether the student is learning the material and supplying correct input or whether the student could use supplemental assistance. From reviewing incorrect input provided by the student, the instructor may also be able to determine a source of a student's errors, such as a concept that the instructor can reinforce for the student. Additionally, in embodiments in which multiple different students interact with the system to solve problems, the instructor may review the input provided by each of the students and determine concepts that the instructor can reinforce for an entire class of students.

As discussed above in connection with FIG. 5, in some embodiments an interactive assignment system may configure a model with one or more random properties in response to input from an instructor. The random properties may be properties of a model that are to be randomly selected when the properties are to be presented to a student. By randomly selecting one or more properties for a model of a problem, the interactive assignment system may be able to create, from one configuration of a problem, a number of slightly different problems for presentation to students. By doing so, the interactive assignment system can create different problems that are to be presented to one student based on one configuration, or may create different problems that are to be presented to different students based on one configuration.

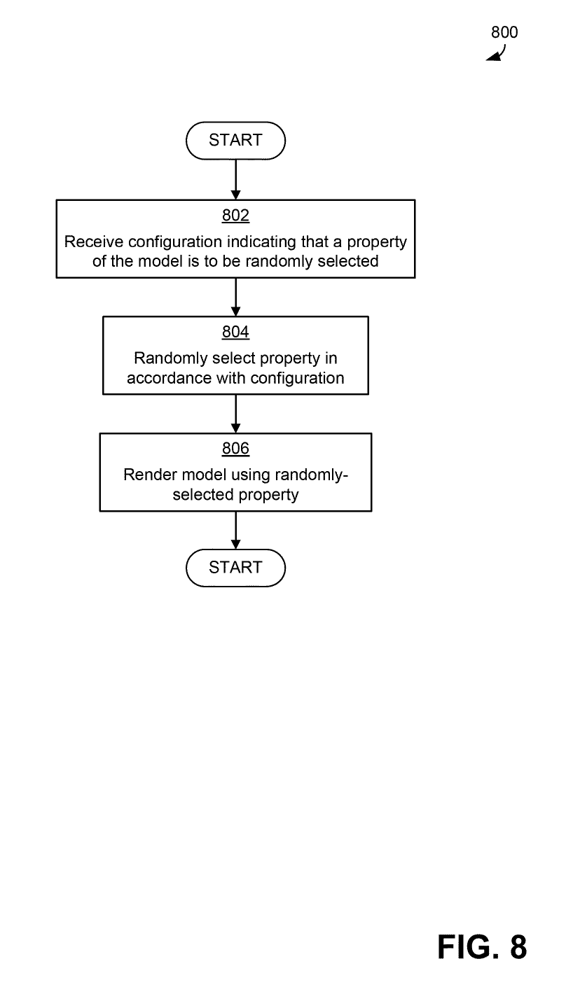

FIG. 8 illustrates an example of a process that an interactive assignment system may perform to present a problem to a student that includes a property that is to be randomly generated. Prior to the start of the process 800 of FIG. 8, a configuration of a problem is created and stored by the interactive assignment system and the interactive assignment system receives a request from a student that a problem be presented. As above in connection with FIG. 7, the request from the student may identify a particular problem to be presented or may request simply that a problem be presented and the system may determine which problem to present.

The process 800 begins in block 802, in which the interactive assignment system, after identifying a problem to be presented, receives a configuration of the problem that indicates that a property of a model of the problem is to be randomly selected. The configuration may, in some cases, indicate limitations on a manner in which the random selection is to be carried out. For example, the configuration may include one or more limitations on a range of values from which a value of a property is to be randomly selected. As discussed above in connection with FIG. 5, a property that is to be randomly selected may have a finite set of potential values and the random selection may be made from the finite set of potential values, or a property may have an infinite set of potential values and a random selection may be made from the infinite set of potential values. In either case, an instructor may have imposed one or more limitations on a potential values for the property, so as to define a subset of potential values that the property may take.

In block 804, in accordance with the configuration, including any limitations set by an instructor, the interactive assignment system randomly selects the property indicated by the configuration. Selecting the property in accordance with the configuration may include selecting the property in accordance with one or more limitations specified by the configuration. Randomly selecting the property may also include randomly selecting any suitable information about the property. For example, a characterization of a property, such as a numeric value of a property, may be randomly selected by the interactive assignment system. As another example, a property that may take one of a finite set of non-numeric values may have a value randomly selected. In some embodiments, a simulation system may simulate based at least in part on materials that compose an object of the model, such as whether the object is composed of one or more materials from a set including wood, metal, ceramic, etc. the material(s) of an object may be a property that may impact other properties of the object and how the object affects other objects in the model. In such cases, the interactive assignment system may randomly select one of the finite set of non-numeric values in block 804. Any suitable property that takes any suitable value, numeric or non-numeric, may be randomly selected in block 804.

Once the property is randomly selected in block 804, the interactive assignment system renders a model using the randomly-selected property. The rendering may be carried out after the random selection such that the random selection can be reflected in the rendering, in a case that the property may affect a visualization of the model. For example, the property that is randomly selected may affect how an interaction of two objects appears in a rendering, such as a location of interaction between two objects like a location at which a force is to act on a beam, or a property that would affect how an object would appear in the rendering, such as a direction of a force. In such cases, rendering the model prior to random selection of the property may result in a visualization of the model that does not accurately reflect properties of the model, including the randomly-selected property. Accordingly, in block 806, following the random selection, the interactive assignment system renders the model using the randomly-selected property.

Following the rendering of the model in block 806, the process 800 ends. Following the process 800, the interactive assignment system may display a visualization of the model and interact with a student using the model. As part of interacting with the student regarding the model, the interactive assignment system may simulate the model using a simulation system. Simulating the model may include performing operations using the randomly-selected property. For example, the system may process a characterization of the randomly-selected property as part of determining a characterization of another property of the model.

The interactive assignment system may be used by an instructor of a course to present problems to students, such as homework problems, in-class assignments, and examinations. As part of presenting problems to students, the interactive assignment system may assign grades for students' work. Once the grades are assigned, the interactive assignment system may store the grades and provide the grades to an instructor.

FIG. 9 illustrates an example of a process that the interactive assignment system may carry out to assign a grade to a student's solution to a problem. Prior to the start of the process 900 of FIG. 9, a configuration of a problem is created and stored by the interactive assignment system and the interactive assignment system receives a request from a student that a problem be presented. As above in connection with FIG. 7, the request from the student may identify a particular problem to be presented or may request simply that a problem be presented and the system may determine which problem to present.

The process 900 begins in block 902, in which the interactive assignment system receives a configuration of a problem that indicates a desired solution to the problem. The indication may indicate the desired solution in any suitable manner. In some embodiments, the indication may merely identify a property to which a desired solution relates. In other embodiments, the indication may be a correct characterization of a property to which the desired solution relates. Where the indication is or includes a correct characterization of the property, the characterization may be in any suitable format, including a format that corresponds to a desired format indicated by the configuration.

In block 904, the interactive assignment system presents the problem to the student. Presenting the problem may be carried out in any suitable manner, as embodiments are not limited in this respect. In some examples discussed above, the interactive assignment system may present a rendering of a model of the problem and a prompt for the desired solution via an interface of the interactive assignment system.

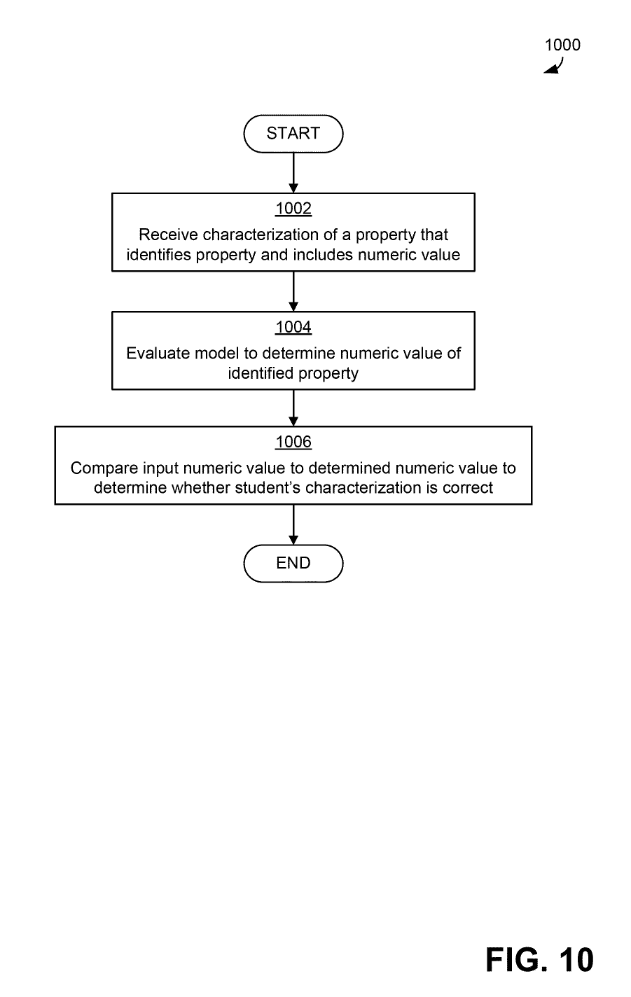

The interactive assignment system may then, in block 906, receive input from the student of a characterization of a property of the system and determine whether the characterization is correct. The system may determine whether the student's characterization is correct in any suitable manner, as embodiments are not limited in this respect. Exemplary techniques for determining whether the student's input characterization is correct are discussed below in connection with FIGS. 10-14. In block 908, the interactive assignment system presents a result of the determination to the student via an interface of the system, informing the student of whether the input characterization is correct or incorrect.

The interactive assignment system may then determine, in block 910, whether the property to which the input characterization relates is the property to which the desired solution relates. If so, then the student is attempting to provide a solution to the problem and the student's solution should be graded in accordance with a grading rubric. Accordingly, if the system determines in block 910 that the student's characterization relates to the same property as the desired solution, then the interactive assignment system proceeds to block 912 and presents a message to the student indicating that the student has provided an answer to the problem. This message may supplement the message presented by the interactive assignment system in block 908 regarding whether the student's input characterization is correct or incorrect. After presenting the message to the student in block 912, in block 914 the interactive assignment system grades the student's solution in accordance with a grading rubric.

The rubric may include any suitable rubric that may be used for evaluating a student's input. In some embodiments, the grading rubric may be used to grade simply whether the student's input is correct or incorrect. In other embodiments, a grading rubric may include grading the student's input based on a variety of factors. For example, the grading rubric may be used to grade a student on a number of significant figures included in a numeric value. If the solution is correct, but does not include a required number of significant figures, the student may be award some amount of partial credit for the answer. As another example, if the student entered multiple characterizations of a property, some of which were correct and some of which were incorrect, in accordance with a grading rubric a student may be presented with some amount of partial credit. Such partial credit for other characterizations may be used in embodiments in which a student is prompted for a particular type of characterization, such as a numeric value of a property, and the student is permitted to input other types of characterizations of the property prior to the particular type that is the desired solution. In such embodiments, the interactive assignment system may determine in block 910 not only whether the student's input characterization relates to the same property as the desired solution, but also whether the student's input characterization is in the same format as the desired solution. In such systems, if a student enters a different type of characterization of the property than is desired, such as by entering a mathematical expression describing the property when the student was prompted to enter a numeric value of the property, then the student may be permitted to continue providing input regarding the property. Once the student provides a characterization of the type desired, the student may be graded on that characterization. In some such cases, however, the grading rubric may allow for the previously-entered characterizations to be factored into a student's grade. This may allow for the student to earn partial credit if, for example, the student provided a correct mathematical expression for the property but provided an incorrect numeric value for the property.

Once a student's input characterization has been assigned a grade by the interactive assignment system in block 914, the process 900 ends. Following the process 900, the interactive assignment system stores a grade for the student's work on the problem, which may be presented to an instructor. If an assignment to be presented by the interactive assignment system includes multiple problems, following the process 900 the interactive assignment system may present to the student another problem of the assignment. Following presentation of each of the problems of the assignment and assignment of grades to a student's work on each of the problems, the system may compile the grades on each of the problems and present an overall grade for the assignment to the instructor.

In the exemplary process 900 of FIG. 9, the process 900 ends once the student provides a characterization of a property to which a desired solution relates, even in a case that the student's input was incorrect. Embodiments may not be limited in this manner. Rather, in some embodiments, after the interactive assignment system presents a message to a student informing the student that the input characterization is incorrect, the student may be permitted to enter new input to the interactive assignment system to attempt to input a correct answer. In some embodiments, the student may be permitted to continue entering characterizations of the property multiple times, without limit, though other embodiments may impose a time limit or other suitable limit on how the student is to solve the problem. In some embodiments, an interactive assignment system may include multiple modes in which a student may enter characterizations and may regulate whether the student is permitted to enter additional characterizations following an incorrect characterization based on the mode. For example, the system may include a “homework” mode in which the student is permitted to enter multiple different characterizations of a property to which the desired solution relates, even after receiving a message indicating that a characterization is incorrect. The system may also include an “examination” mode, however, in which the student is not permitted to enter different characterizations of the property to which the desired solution relates after inputting a characterization in the format of the desired solution.

As mentioned above, the interactive assignment system may provide feedback to a student indicating whether a characterization of a property input by a student is correct or incorrect. The interactive assignment system may use any suitable technique to determine whether a student's input characterization of a property is correct or incorrect, as embodiments are not limited in this respect. In some embodiments, the interactive assignment system may compare a stored listing of characterizations of properties and inform the student of whether the student's input characterization matches a characterization of the property in the listing. In other embodiments, however, the interactive assignment system may perform simulations involving a model of the problem to determine a correct characterization and compare the student's input characterization to the correct characterization determined from the model.

FIGS. 10-14 illustrate examples of processes that may be performed by an interactive assignment system to determine whether a student's input characterization is correct. It should be appreciated that embodiments are not limited to implementing any or all of the exemplary processes illustrated in FIGS. 10-14.

Prior to the start of each of the processes of FIGS. 10-14, a problem is configured by an interactive assignment system in response to input from an instructor and the configuration of the problem is used to present the problem to a student. A rendering of a model of the problem is presented to the student together with a prompt for a desired solution. The student is then permitted to enter a characterization of a property, which may be different from a property to which a desired solution relates.

The process 1000 of FIG. 10 may be used to determine whether a characterization of a property input by a student that is a numeric value of the property is correct. The process 1000 begins in block 1002, in which a characterization of a property is received that identifies the property and includes the numeric value (e.g., “F=10 Newtons”). In block 1004, in response to receiving the characterization from the student, a simulation system of the interactive assignment system may determine a correct numeric value of the property using the model. To determine the numeric value of the property, the simulation system may process the model in any suitable manner, including by processing properties of the model and information about objects of the model, relationships between properties of the model, or a scenario of the model. For example, the simulation system may have stored information regarding relationships between properties of a model, including properties of objects of the model, and may evaluate these functions together with a configuration of the model. Where a configuration of the model includes a numeric value of a property, for example, the simulation system may retrieve the numeric value of that property and insert that numeric value into the function that relates to the property. In some cases, the configuration of the model may not directly include a numeric value of a particular property, but a numeric value of the property may be determinable from other numeric values included in the configuration of the model. Accordingly, to determine the numeric value of the property to which the student's input characterization relates, the simulation system may perform one or more calculations involving properties of the model identified by the configuration. The simulation system may perform any suitable calculations in any suitable manner.

In some embodiments, for example, the simulation system may identify a mathematical function that defines a numeric value of the property to which the student's input characterization relates and that includes variables that correspond to other properties of the model. The mathematical function may be one that was prestored by the simulation system and/or may be one that was determined from an arrangement of objects in the model. For example, for an engineering statics problem, a simulation system may include a stored function that defines a force that one object may apply to a point on another object, which may be based on multiple variables including a distance between a location of interaction of the two objects and forces acting on the one object. The simulation system may determine a mathematical function relating to the forces acting on a particular point of an object through applying that stored function to each of the other objects acting on that object. Thus, while the simulation system included a stored function that identified a relationship between properties of the model, the simulation system may adjust the function based on the objects included in the model and an arrangement of the objects in the model.

Once the simulation system determines a function that can be used to calculate a numeric value for the property to which the student's input characterization relates, the simulation system may attempt to solve the function to calculate a numeric value. To do so, the simulations system may access information about the other properties corresponding to the variables of the function. For example, the simulation system may determine whether the configuration includes numeric values of these other properties and, if not, determine functions that define numeric values of these other properties and attempt to solve those functions. In some embodiments, the simulation system may carry out a depth-first search of variables included in each of the functions defining each of the properties until the simulation system identifies numeric values of properties that can be used to solve a function and determine numeric values of another property. The simulation system may then continue to use substitute numeric values determined for properties into functions until the simulation system acquires each of the numeric values needed to solve the function defining the property to which the student's input characterization relates. The simulation system may then determine the numeric value of the property and thereby determine a correct characterization of the property using the model.

Once the simulation system determines the correct characterization of the property, which in the example of FIG. 10 is the numeric value of the property according to the numeric values of the model, the interactive assignment system compares the correct characterization to the student's input characterization in block 1006. The comparison may be carried out in any suitable manner, as embodiments are not limited in this respect. For example, the interactive assignment system may round the correct numeric value such that the correct numeric value has the same number of digits as the student's input numeric value and then determine if the numeric values are equal. If the values are equal, then the student's input characterization is determined to be correct.

Once the interactive assignment system determines whether the student's input characterization is correct, the process 1000 ends. Following the process 1000, the system may store information indicating whether the student's input was correct and present a message to the student indicating whether the student's input was correct.

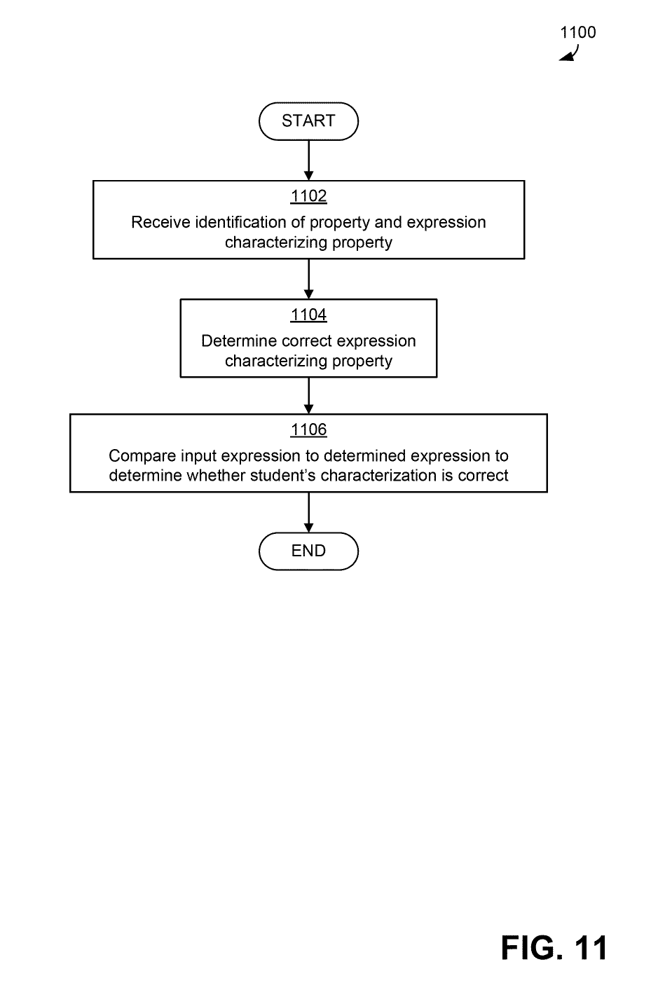

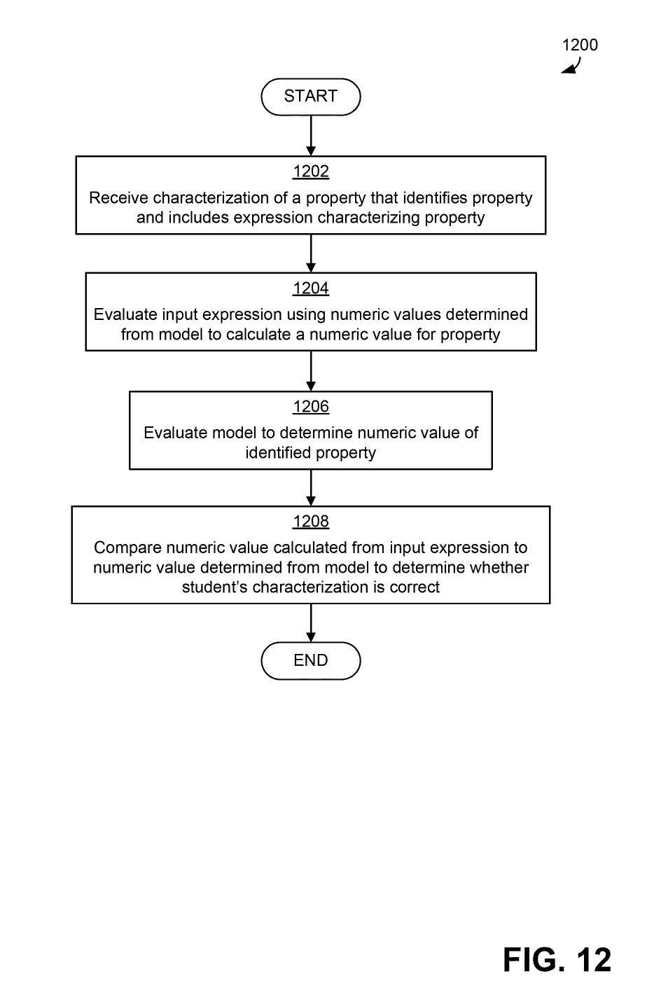

As discussed above, a student may enter various types of characterizations into an interface of the interactive assignment system. Among the types of characterizations that a student may input is a numeric value, such as the numeric value input in the example of FIG. 10. Another type of characterization that the student may input is an expression describing a property, such as an equation that defines a value of a property. FIGS. 11 and 12 illustrate examples of processes that may be carried out by an interactive assignment system to determine whether an expression input by a student is correct.

The process 1100 of FIG. 11 begins in block 1102, in which the interactive assignment system receives a characterization of a property that identifies the property and includes an expression characterizing the property. The expression may be in any suitable form, including an equation defining the property that includes a variable for the property on the left-hand side of the equation and a mathematical function on the right-hand side of the equation. Embodiments are not limited to operating with any particular form of expressions or any particular form of equations.

In block 1104, the simulation system may determine an expression that characterizes the property by evaluating the model. The simulation system may determine the expression in block 1104 similarly to how the simulation system determined a numeric value in block 1004 of FIG. 10. In particular, the simulation system may identify a stored function that includes one or more variables and that defines a numeric value of the property to which the student's input expression relates. In some embodiments, as discussed above in connection with block 1004, the simulation system may evaluate the objects of a model and an arrangement of objects of a model to determine a function that characterizes a property.

Once the simulation system determines a correct expression that characterizes a property in block 1104, the interactive assignment system compares the correct expression to the student's input expression in block 1106 to determine whether there is a match. To determine whether there is a match, the interactive assignment system may compare the expressions to determine whether the variables and mathematical operators of the expressions are identical. If so, then the expressions may be determined to be equal. If the expressions are equal, then the student's characterization is determined to be correct and the process 1100 ends.

In some embodiments, however, determining whether a correct expression for a property matches a student's input expression may not be implemented as a simple process of determining whether there is an identical match. This may be because a property may be characterized by multiple different expressions, or expressions in different forms may be equivalent to one another. Thus, in some embodiments, the interactive assignment system may carry out other operations to determine whether a student's input expression matches a correct expression.

For example, in some embodiments, the simulation system may alter an expression characterizing a property by rearranging parts of the expression in a way that maintains mathematical equivalence, such as by changing the order of variables that are joined by a multiplication operator or addition operator. As another example, the simulation system may substitute for a variable in the function another function that defines the numeric value of that variable, such that the resulting function is an expanded version of the original function. Once such substitutions are carried out, the interactive assignment system may compare the resulting expressions to the expression input by the student to determine whether there is a match.

In some cases, there may be a large number of such substitutions that could be carried out to determine whether the expressions are equivalent. Accordingly, in some embodiments, an interactive assignment system may additionally or alternatively evaluate the expressions using numeric values to determine whether the expressions yield matching numeric values and therefore whether the expressions are equivalent.

FIG. 12 illustrates an example of a process that may be used in some embodiments to determine whether expressions are equivalent using numeric values. The process 1200 begins in block 1202, in which (similar to block 1102 of FIG. 11) the interactive assignment system receives a characterization of a property from a student that includes an identification of a property and an expression characterizing the property. The expression that is input by the student may include one or more variables, each of which may correspond to a property of the model of the problem. The simulation system may determine a correspondence between the variables of the expression and the properties of the model. To determine a correspondence between the variables of the equation and properties of the model, the simulation system may review a listing of notations associated with properties of the model to determine whether a variable included in the expression is included in the notations. When the simulation system identifies the variable in the listing of notations, the simulation system may identify that the variable in the expression corresponds to a property of the model. The simulation system may then determine a numeric value for that property of the model, such as by retrieving the numeric value from the configuration of the model and/or by evaluating one or more functions to determine numeric values for the properties from the model.

Once the simulation system identifies numeric values corresponding to each of the variables in the expression input by the student, in block 1204 the simulation system may evaluate the expression using the numeric values. To do so, the simulation system may interpret the expression input by the student and the mathematical operations included in the expression. For example, the simulation system may interpret the expression and determine that a “*” character included in the expression relates to a multiplication operation, or that a “̂” character relates to an exponential operation. The simulation system, upon identifying mathematical operations to be carried out to evaluate the student's input expression, may then apply mathematical rules such as order of operations rules and evaluate the expression using the numeric values for the variables. Through evaluating the student's input expression, the system may determine a numeric value for the expression.

The simulation system may also, in block 1206, determine a correct numeric value for a property to which the student's input expression relates. The simulation system may determine the correct numeric value in any suitable manner, including using exemplary techniques discussed above in connection with block 1004 of FIG. 10.

Once the simulation system has determined a numeric value from the student's input expression and a correct numeric value from evaluating the model, the system may compare the numeric values in block 1208. The comparison of block 1208 may be carried out in any suitable manner, including using exemplary techniques discussed above in connection with block 1006 of FIG. 10.

If, through the comparison of block 1208, the interactive assignment system determines that the numeric values are equivalent, then the interactive assignment system determines that the student's input expression has yielded a correct value for the property. Because the student's input expression has yielded a correct value, the interactive assignment system determines that the student's input expression is correct. If, however, the values are determined not to be equivalent, then the student's input expression has yielded an incorrect value and may be determined to be incorrect. Once the interactive assignment system has determined whether the student's input is correct or incorrect, the process 1200 ends.

Following the process 1200, the interactive assignment system may store information indicating whether the student's input was correct and present a message to the student indicating whether the student's input was correct.

The process 1200 of FIG. 12 was described using an example of a student's input expression that defines a property and results in a single numeric value for a property. This may be the case with an equation that defines a numeric value for a property, such as an equation that includes the property on the left-hand side and a function that defines the numeric value on the right-hand side. It should be appreciated, however, that embodiments are not limited to operating with expressions in any particular form and are not limited to operating with input equations that define numeric values of properties. For example, rather than an equation that defines a numeric value of a property and that includes only a single variable on one side of the equation, a student may input an equation relating two different expressions. This may be the case where a student is exploring a relationship between two objects. For example, a student may believe that the momentum of two objects in the simulation is equivalent, and enter a correspondence equation that the product of the mass and velocity for each object is equivalent (e.g., “m₁*v₁=m₂*v₂”). In some such embodiments, the process 1200 of FIG. 12 or a similar process may be carried out to determine whether the student's expression is correct. For example, numeric values corresponding to each of the variables in the expression may be determined from the model and the expression may be evaluated to determine whether the expression is correct.

It should also be appreciated that embodiments are not limited to operating with expressions that are equations. In some embodiments, an interactive assignment system may operate with expressions that are inequalities and determine whether an inequality is correct. For example, a student may enter an expression such as “F₁>F₂” indicating that a force associated with one object has a greater magnitude than a force associated with another object. Using the techniques described above in connection with FIG. 12, the interactive assignment system may determine whether the student's input inequality is correct.

In some embodiments, the interactive assignment system may enable students to enter input regarding any suitable property, including properties other than a property to which a desired solution relates. The input regarding the properties may include input that identifies a relationship between two properties, such as an expression that identifies an equivalence between two properties or identifies that a value of one property is a function of another. One example of such an expression is the “m₁*v₁=m₂*v₂” example of momentum given above, which identifies a relationship between the mass and velocity of one object and the mass and velocity of another object. Another example of such an expression is the expression “F=10*a,” which identifies a relationship between a force associated with an object and an acceleration of that object (with a mass of the object in this example being set to the numeric value 10).

When the student enters an expression characterizing a relationship between two or more properties, the expression may be evaluated for whether the expression is correct, as discussed above. However, it may be the case that the expression and the relationship characterized by the expression is merely coincidentally correct. An expression may be coincidentally correct because the expression is correct given the numeric values of properties with which the model is configured and not because the expression is a correct characterization of a scenario that the model is to simulate. For example, a known equation characterizing a force of an object is that the force is equal to the product of the mass of an object and the acceleration of that object. However, it is possible that a student may, as a mistake, enter an expression into the interactive assignment system that substitutes the mass and acceleration of a second object, such that the student's input characterization is “F₁=m₂*a₂”: the force associated with object 1 is equal to the product of the mass of object 2 and the acceleration of object 2. This is not a correct equation and the relationship between the force of the one object and the mass and acceleration of the other may be incorrect. However, it may be that, as a coincidence, an instructor input a numeric value of the force of object 1 as 10 Newtons, the mass of object 2 as 10 kilograms, and the acceleration of object 2 as 10 meters-per-second-squared. Thus, if the student's input equation is evaluated, the student's input equation would be marked correct, because 10=10*1. However, the student's expression is, as mentioned above, actually incorrect because the relationship characterized by the expression is incorrect. Thus, the student's expression is merely coincidentally correct for the numeric values of the model of the problem. If the student were informed that the expression was correct, however, the student may be misled into believing that the expression is correct, leading to an error in what the student has learned.

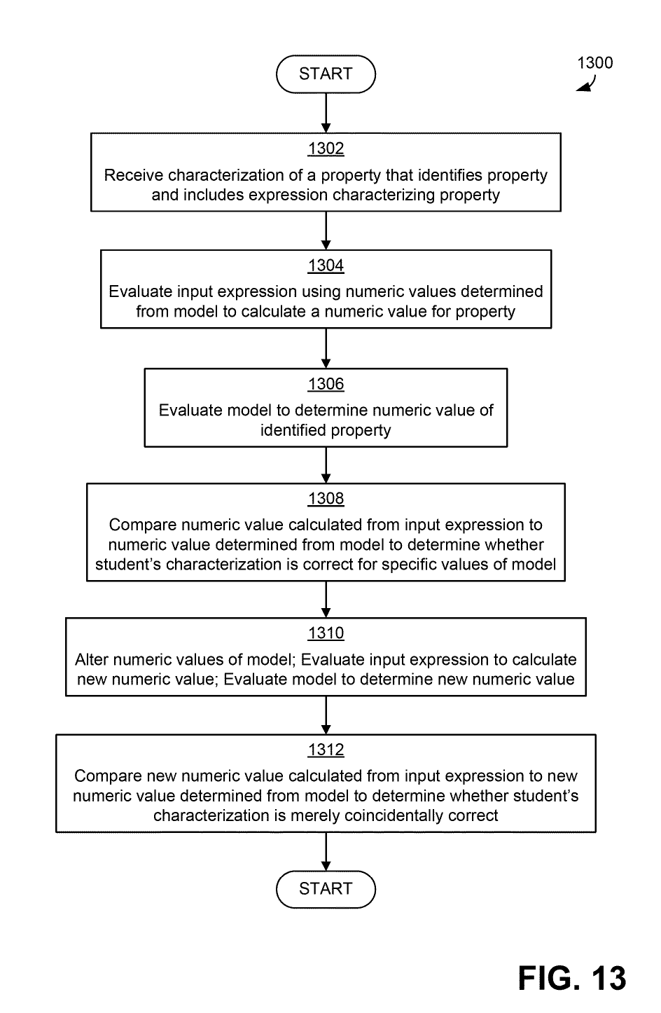

In some embodiments, an interactive assignment system may be able to determine, when evaluating an expression input by a student and in response to determining that the expression is correct, whether the expression is coincidentally correct. FIG. 13 illustrates an example of a process for determining whether a student's input expression is coincidentally correct.

Process 1300 of FIG. 13 begins in block 1302, in which the interactive assignment system receives a characterization of a property that identifies the property and includes an expression characterizing the property. In block 1304, the simulation system of the interactive assignment system evaluates the input expression using numeric values determined from the model and, in block 1306, determines a correct numeric value for the property using the model. The interactive assignment system may then, in block 1308, determine whether the numeric value yielded by the student's input expression matches the numeric value determined from the model and, thus, whether the input expression is correct. The operations of blocks 1302-1308 of process 1300 may be implemented in any suitable manner, including using the exemplary techniques described above in connection with blocks 1202-1208 of FIG. 12.

In response to determining in block 1308 that the student's input expression is correct, the interactive assignment system may proceed to determine whether the student's input expression is merely coincidentally correct. Accordingly, in block 1310, the simulation system may alter numeric values of one or more properties that were used in block 1304 to evaluate the student's input equation and/or one or more of the properties that were used in block 1306 to determine a correct numeric value. For example, using the “F₁=m₂*a₂” example above, the simulation system may alter a numeric value of the acceleration from 1 meter-per-second-squared to 5 meters-per-second squared. The simulation system may alter the numeric values in any suitable manner and by any suitable amount, as embodiments are not limited in this respect. Once the simulation system has altered the numeric values of one or more properties, the simulation system may, in block 1310, repeat the operations of blocks 1304 and 1306 using the new values to calculate new numeric values from the student's input expression and from the model. By using the new values of the properties to determine new numeric values from the expression and the model, the simulation system may determine whether the student's input expression is correct for more than the numeric values with which the model was configured. If the student's input expression is correct for more than the numeric values with which the model was configured, it is unlikely or less likely that the student's input expression is merely coincidentally correct.

In block 1312, once the new numeric values are calculated in block 1310, the interactive assignment system compares the new numeric values to determine whether the values are equivalent. If the values are equivalent, then the students' input expression may be determined to be more than coincidentally correct. If the values are not equivalent, then the student's input expression may be determined to be merely coincidentally correct. Once the interactive assignment system determines whether the student's input expression is or is not coincidentally correct, the process 1300 ends.

Following the process 1300, the interactive assignment system stores information regarding the student's input, whether the input was correct, and whether the input was coincidentally correct. The interactive assignment system may then interact with the student regarding the student's input, such as by presenting a message to the student indicating that the student's input was correct and, if the input was merely coincidentally correct, a message that the student's input was correct only for the specific numeric values of the model. The message presented to the student that the input was correct only for the specific numeric values of the model may include an indication that the student's input would be incorrect for other numeric values.

In the example of FIG. 13 described above, the simulation system was described as altering the numeric values of one or more parameters once and determining based on that alteration whether a student's input expression is coincidentally correct. It should be appreciated that embodiments are not limited to determining whether an expression is coincidentally correct by making one alteration to numeric values of one or more properties. In some embodiments, the simulation system may make multiple alterations to one or more properties to determine whether an expression is coincidentally correct. For example, in some embodiments, the simulation system may perform a first set of one or more alterations to one or more properties that includes altering the numeric values to be higher than the numeric values with which the model is configured, and may perform a second set of one or more alterations to the properties that includes altering the numeric values to be lower. It should be appreciated that the simulation system may alter the numeric values of any suitable number of properties any suitable number of times and by any suitable amount, as embodiments are not limited in this respect.

As mentioned above, embodiments are not limited to accepting as input from a student a characterization of a property of a model that is of any particular type of characterization. In the example of FIG. 10, the input characterization was a numeric value. In the examples of FIGS. 11-13, the input characterization was an expression. In some embodiments, an interactive assignment system may be able to accept as input from a student a model. The model that is input by the student may relate to the problem and may relate to one or more properties of the model of the problem. For example, the model that is input by the student may be a simplified or reduced form of the model of the problem with which the problem is configured. The simplified or reduced model may relate to the model of the problem in any suitable manner. In an engineering statics scenario, a model of a problem may include multiple objects interacting with one another and the simplified or reduced model may be a free body diagram of forces acting on the objects or the forces acting on a particular object of the model. In an electric circuits scenario, the model of the problem may include an electric circuit with objects corresponding to multiple different circuit elements and the simplified or reduced model may be a Thevenin or Norton equivalent circuit to the circuit of the model of the problem. Thus, in some cases the model input by a student may describe a relationship among objects in the model of the problem that is presented to a student. Additionally, in some cases the model that is input by the student may be the desired solution to the problem for which a student is prompted by an interactive assignment system, while in other cases the model may be input by the student without the student being prompted to enter the model.

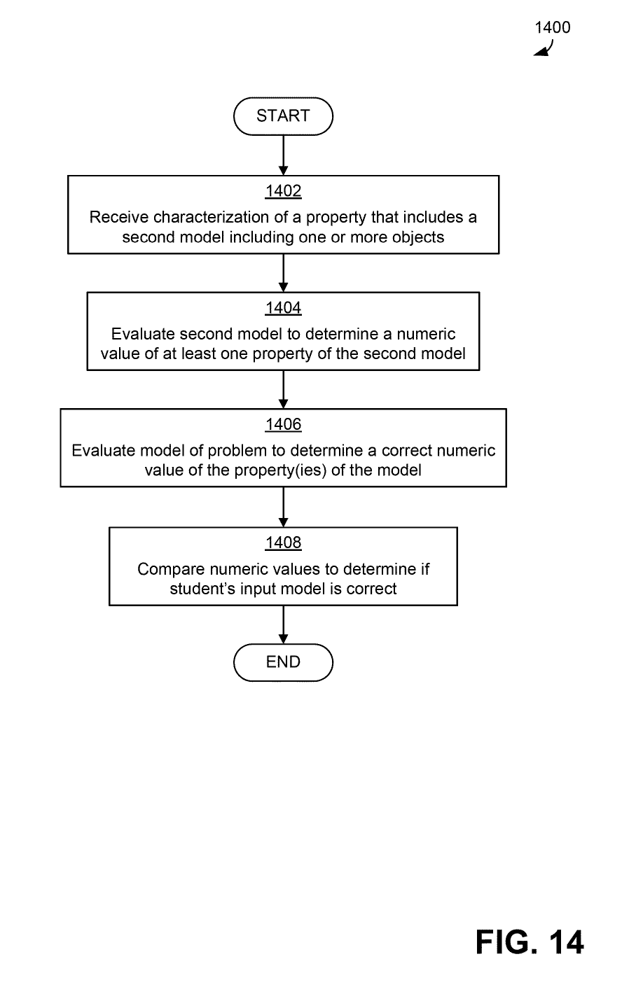

FIG. 14 illustrates an example of a process that an interactive assignment system may implement to determine whether a student's input characterization of a property of a model is correct in a case that the input characterization is a model relating to the property. The property to which the input model relates may be any suitable property of the model, as embodiments are not limited in this respect. In some cases, the property of the model to which the student's input model relates may be a property regarding an effect of interactions of objects on an object or a result of interactions of objects of the model of the problem. A property regarding an effect of interactions may be, for example, a property relating to the forces acting on a point in the model.

Prior to the start of the process 1400 of FIG. 14, a configuration of a problem, including a configuration of a model of a problem, is stored by an interactive assignment system and is used by the system to present the problem to a student in an interface of the system. The interface that is presented to a student prior to the start of the process 1400 may include tools that the student may use to provide input to the system regarding a model. This interface may be similar to the interface presented to an instructor for providing input regarding a model of a problem as discussed above in connection with FIG. 3C and discussed in connection with FIG. 5. For example, in some embodiments, the interface that is presented to the student may include a listing of objects that may be included in a model that the student may use to select objects for inclusion and may include a prompt for the student to enter values for one or more properties of an object.

The process 1400 begins in block 1402, in which the interactive assignment system includes a characterization of a property, where the characterization that is received includes an input model that includes one or more objects defined according to user input. The second model may have been configured by the system in response to input from a user regarding the objects to be included in the second model and properties of the objects included in the second model.

In block 1404, the simulation system evaluates the model to determine a numeric value of at least one property of the second model that was input by the student. To determine the numeric value(s), the simulation system may apply any one or more functions, as discussed above in connection with FIGS. 10-12. Similarly, the simulation system may, in block 1406, determine a correct numeric value of the property or properties from the model included in the configuration of the problem. In block 1408, the simulation system may compare the numeric values to determine whether the numeric values are equivalent. If the numeric values are equivalent, then the student's input model may be marked as correct. If the numeric values are not equivalent, then the student's input model may be marked as incorrect.

The property or properties for which the numeric values are calculated in blocks 1404 and 1406 may be any suitable properties. In some cases, the properties may be related to the property for which the student generated the input model. For example, if a student generates the second model as a free body diagram of an object of the model of the problem, the simulation system may determine numeric values for all reaction and external forces in the object in the model of the problem and in the student's input model. As another example, in the case of a free body diagram, the one or more properties for which numeric values are calculated may be magnitudes and directions of forces in the models. Two statically-equivalent diagrams will include equivalent sums of the forces and sums of moments in the diagrams. The simulation system may therefore calculate the forces, moments, and sums of both in the input model and the model of the problem to determine whether the student's input model is statically equivalent to the model of the problem. If the models are statically equivalent, then the student's input model may be marked as correct. Accordingly, based on the property to which the desired solution relates, the simulation system may determine numeric values of properties that may indicate whether the model input by the student is correct.

Once the interactive assignment system determines in block 1408 whether the student's input model is correct, the process 1400 ends. Following the process 1400, the interactive assignment system may store information indicating whether the student's input was correct and present a message to the student indicating whether the student's input was correct.

As should be appreciated from the foregoing discussion of FIGS. 10-14, the interactive assignment system may prompt a student to enter a characterization of a property that may be in any of multiple different formats. For example, the interactive assignment system may prompt a student to enter a numeric value, an indication of units of a property, an expression characterizing a property, a model characterizing a property, or any other suitable characterization of a property. Accordingly, the interactive assignment system may, in some embodiments, present to a student an interface that is tailored to a manner in which the student is to be prompted to enter input.

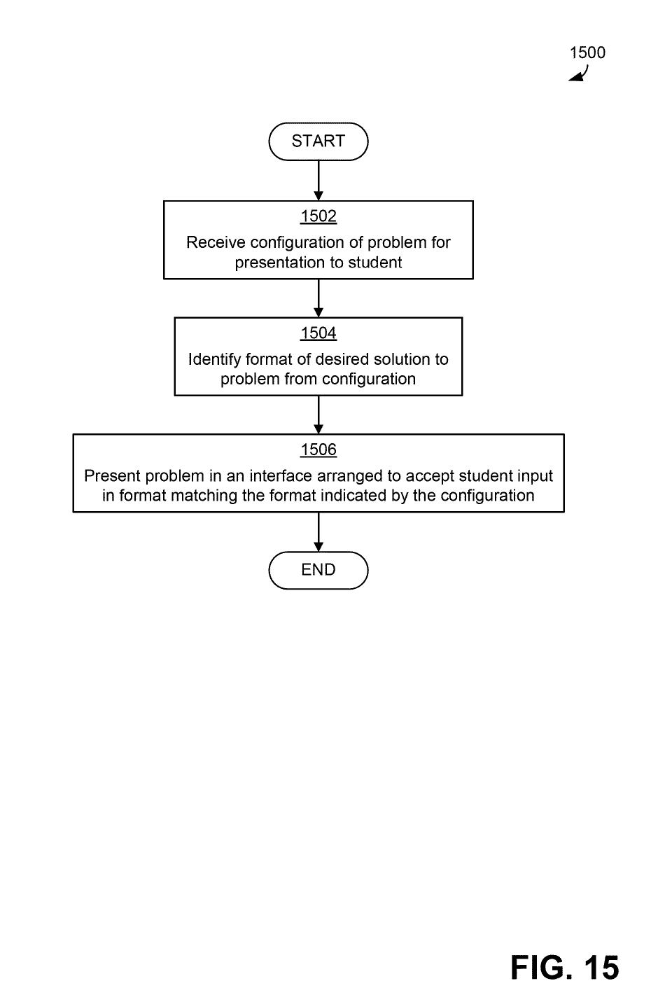

FIG. 15 illustrates an example of a process that an interactive assignment system may implement to present an interface to a student that is tailored to a manner in which the student is to enter input. Prior to the start of the process 1500 of FIG. 15, the interactive assignment system may store a configuration of a problem that includes an indication of a desired solution and a type of characterization that the student is to input as the desired solution. Additionally, the interactive assignment system may receive from a student a request to present a problem and determine a problem to present to the student.

The process 1500 begins in block 1502, in which the interactive assignment system receives a configuration of a problem that is to be presented to a student. The configuration of the problem includes an indication of a format of desired solution that a student is to input and, in block 1504, the interactive assignment system determines the format. Based on the format of the desired solution, in block 1506 the system may tailor an interface that is presented to a student. For example, in embodiments in which an interface presented to a student is a web interface including one or more web pages, the system may tailor the contents of the web page(s). An interface may be tailored for the format of the desired solution by including one or more interface elements that enable the student to provide input in the desired format. For example, if the format of the desired solution is a numeric value, the interface may include a text box into which a student may enter a numeric value. As another example, if the format is an expression, the interface may include interface elements corresponding to tools by which a student may input an expression, such as tools for building an expression. The tools for building an equation may include tools for adding mathematical symbols to the expression, such as icons corresponding to mathematical symbols and a graphical element that may be updated as the student adds symbols to the expression. As another example, if the format is a model, the interface may include interface elements for providing input regarding a model, such as a listing of types of objects that may be included in a model and a listing of properties of the objects regarding which the student may provide input. As a further example, if the format is a selection of a multiple choice option, the interface may include a listing of the multiple choices and elements corresponding to each that enables the user to select an option.

Once the interface has been tailored to enable the student to provide input in a format that corresponds to the format of the desired solution, in block 1506 the problem may be presented to a student in the tailored interface. Once the problem is presented, the process 1500 ends. As a result of the process 1500 of FIG. 15, the student views the problem and is able to provide input in a desired format. Therefore, following the process 1500 of FIG. 15, the interactive assignment system may receive input from a student in a format that corresponds to the format of the desired solution that is indicated by a configuration of the problem.

In embodiments of an interactive assignment system discussed above, a system may receive input from a student regarding one or more properties and provide information to the student regarding the input and regarding the one or more properties. In various examples described above, the interactive assignment system presents to a student feedback that includes whether an input characterization of a property provided by a student is correct. In some embodiments, an interactive assignment system may additionally or alternatively present to a student educational messages regarding characterizations input by a student, if the interactive assignment system determines that a characterization is incorrect. The characterizations may include information identifying to a student an error that the student has made that resulted in the student providing an incorrect input. Through providing the educational messages to the student, the interactive assignment system may be able to educate the student and enable the student to subsequently provide a correct characterization to the interactive assignment system.

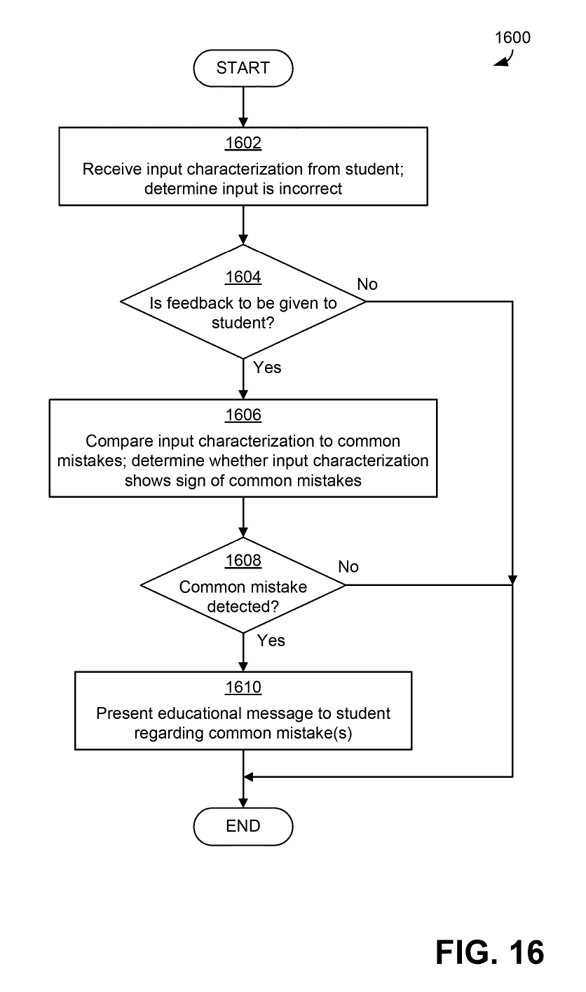

FIG. 16 illustrates an example of a process that the interactive assignment system may implement in some embodiments for presenting educational messages to a student in response to receiving an input characterization from the student. Prior to the start of the process 1600 of FIG. 16, an interactive assignment system stores a configuration of a problem and presents that problem to a student in an interface of the interactive assignment system. The configuration of the problem, or an assignment of which the problem forms a part, may include an indication of a mode in which the interactive assignment system is to operate when presenting the problem to a student, as discussed in greater detail below in connection with block 1604 of FIG. 16. The indication of the mode may have been set by the interactive assignment system in response to input regarding the mode from an instructor.

The process 1600 begins in block 1602, in which the interactive assignment system receives an input characterization from the student and determines that the input characterization is incorrect. The interactive assignment system may receive the characterization and determine that the characterization is incorrect in any suitable manner, including using exemplary techniques discussed above. In block 1604, the interactive assignment system determines whether feedback is to be presented to the student, which the system may determine from examining a mode in which the system is to operate when presenting the problem. As mentioned above, in some embodiments, the interactive assignment system may be operable in multiple different modes, each of which may correspond to a different amount of feedback that may be presented to a student. For example, in an in-class activity mode, the system may operate to present feedback to a student including indications of whether the student's input is correct or incorrect and educational messages regarding errors detected in a student's work, as discussed below. In a homework mode, also, the system may present educational messages regarding errors detected in a student's work, or the system may merely indicate whether a student's input is correct or incorrect. In an examination mode, however, the system may not indicate to a student whether the student's input is correct or incorrect, but may merely log that the student's input is correct or incorrect for grading purposes, such that the student is informed of whether their input was correct or incorrect together with an overall grade for the examination. Thus, the interactive assignment system may determine in block 1604 whether the system is to present feedback to the student by examining a mode in which the system is to operate when presenting the problem to the student. If the system determines that the system is not to present feedback to the student, then the process 1600 ends.

If, however, the system determines in block 1604 that the system is to present feedback to the student in the form of educational messages regarding potential errors in a student's work, then the system continues to block 1606. In block 1606, the system compares the student's input to one or more common mistakes with which the system is configured. By comparing the student's input to the common mistakes, the system may determine whether the student's input characterization shows a sign that the student made one of the common mistakes in the input, which may have resulted in the student's input characterization being incorrect.

The interactive assignment system may be configured with any suitable listing of mistakes. The common mistakes with which the system is configured may be considered common for any reason. For example, the system may be configured with mistakes that an instructor or an administrator of the system has observed students making often. It should be appreciated, however, that embodiments are not limited to being configured with any particular set of mistakes or mistakes that have met any particular criteria.

Each common mistake with which the system is configured may include a sign of a mistake and an educational message explaining the mistake. The sign of the mistake may be any indication of the mistake that the interactive assignment system may observe in a student's input. In some cases, the sign of the mistake may be a substitution that the student may have made that was a mistake that resulted in the incorrect input. For example, one mistake may relate to properties of the model that a student may confuse and substitute for one another. For example, a student may accidentally substitute acceleration for velocity in equations, such as in an equation like “F=m*a”. As a result of the substitution, the student may produce an incorrect numeric value that is input to the system. To determine whether the student has made an error by swapping acceleration and velocity, the system may determine whether a property to which the student's input relates is dependent on acceleration or on velocity. The system may determine whether the property is dependent on acceleration or on velocity in any suitable manner, such as by reviewing functions with which the simulation system is configured that indicate a relationship between properties. If the interactive assignment system determines from the function that the property is dependent either on acceleration or velocity, the system may replicate the common mistake by substituting a numeric value of one for the other. For example, the system may review a function that defines a numeric value of the property to which the student's input characterization relates and determine that the function (and thus a numeric value of the property) is dependent on acceleration. In response, the system may attempt to replicate the error and perform a calculation using the function, but using a numeric value for velocity in place of the correct numeric value for velocity. The system may then compare the incorrect numeric value produced as a result of the substitution to the student's incorrect input characterization to determine if there is a match. If there is a match, then the system may determine that the student made that common mistake and that the common mistake resulted in the student's incorrect input.

The interactive assignment system may be configured with any suitable mistakes, as embodiments are not limited in this respect. Examples of mistakes include substituting one trigonometric function for another (e.g., substituting a sine function for a cosine function), substituting degrees for radians in a function or vice versa, flipping a sign of a value in a function such that the value becomes incorrectly positive or negative, substituting a Centigrade temperature for a Fahrenheit temperature in a function or other mistake involving confusion of units, or any of a variety of other mistakes. Other examples of mistakes include mistakes that do not result from incorrect substitutions, but may result from incorrect calculations in known functions that relate to a particular property. For example, where a property is related to a function, such as having a numeric value that is defined by the function, a common mistake may be to leave out a mathematical operation from the function or to mix up the order of operations of the function. For example, for determining a magnitude of a vector, a correct calculation includes evaluating a square root of a sum of squared values of magnitudes of components of the vector. A common mistake in such a case may be to forget the square root and only sum the squares of the magnitudes, or to take the square root of the sum of the magnitudes rather than the sum of the squares of the magnitudes.

In block 1606, the interactive assignment system may evaluate each of the common mistakes with which the system is configured to determine whether the mistake is relevant to the student's input. The mistake may be determined to be relevant when the mistake includes a sign of a mistake that the system observes in the student's input. For example, when the sign of a mistake includes two properties that a student may accidentally substitute for one another and the system observes that the property to which the student's input relates is dependent on either of the two properties, the mistake may be determined to be relevant to the student's input. As another example, a sign of a common mistake may be that the student's input relates to a particular property, such as is the case where a common error is associated with a particular property. In response to determining that a mistake is relevant to the student's input, the system may replicate the mistake by performing processing of properties of the model based on the mistake to determine a characterization of a property. For example, the system may perform a calculation in which the system substitutes a numeric value of one property for another so as to make the mistake. After performing the calculation, the system may compare the incorrect characterization resulting from the processing based on the mistake to the student's input. If the characterization resulting from the processing based on the mistake matches the student's input, then the interactive assignment system may detect that the student may have made the mistake.

Accordingly, in block 1608, the interactive assignment system determines whether the system has detected a common mistake in the student's input. If the system determines in block 1608 that a mistake is detected and that the student may have made the mistake, then the interaction assignment system presents an educational message to the student in block 1610. The educational message that the system presents in block 1610 may be a message that is related to the common mistake, such as a message that forms a part of a configuration of the common mistake. Any suitable message may be presented, such as a message suggesting that the student check their work for the mistake that was detected. For example, continuing with the example of acceleration and velocity used above, the system may present a message to the student that the student should “Check whether you have correctly used a value for acceleration, and not a value for velocity” or other similar message.

Once the interactive assignment system has presented an educational message to the student via an interface of the system in block 1610, or if the system determines in block 1608 that no common mistakes were detected, the process 1600 ends. Following the process 1600, in some cases, the student may present further characterizations of the same property to the system as input, which may include a correct characterization of the property. Additionally, as a result of the process 1600, the interactive assignment system may store information regarding the student's incorrect input and any common mistakes that were detected in the student's input. The information regarding the student's input and mistakes may be presented by the interactive assignment system to an instructor, such that an instructor may review the student's mistakes and determine whether the student may require assistance and what kind of assistance to provide to the student.

Information regarding common mistakes with which an interactive assignment system may be used in a variety of ways in different embodiments in which a system includes information regarding common mistakes. For example, in some embodiments, the common mistakes may be used to determine whether a student's input includes indications of common mistakes, as discussed above in connection with FIG. 16. In some embodiments, the interactive assignment system may additionally or alternatively use the information regarding common mistakes to generate incorrect information to provide to a student. For example, for a multiple choice problem, the interactive assignment system may present a number of options to a student in an interface, including a correct option and a number of incorrect options. In some embodiments, the interactive assignment system may use information regarding common mistakes to generate the incorrect options for a multiple choice problem.

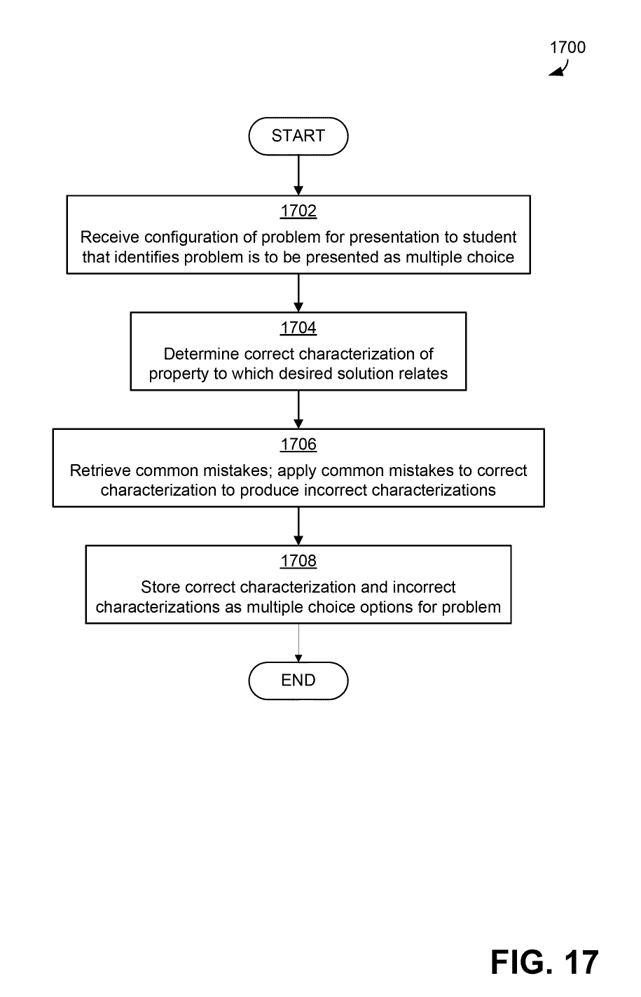

FIG. 17 illustrates an example of a process that may be used by an interactive assignment system to determine multiple choice options for a problem based at least in part on common mistakes with which the system is configured. As discussed above in connection with FIG. 16, a configuration of a common mistake may include the mistake as well as a sign of the mistake. Prior to the start of the process 1700 of FIG. 17, the system is configured with the information regarding one or more common mistakes and stores a configuration of a problem that may be presented to a student. The configuration of the problem includes an indication of a desired solution and an indication that the problem is to be presented to a student as a multiple choice problem. Additionally, prior to the start of the process 1700, the interactive assignment system presents an interface to a student, receives from the student a request to present a problem to the student, and determines a problem that the system is to present to the student.

The process 1700 begins in block 1702, in which the interactive assignment system receives a configuration of a problem that identifies that the problem is to be presented as a multiple choice problem. The configuration that is received in block 1702 also indicates a property to which a desired solution to the problem relates. In response to receiving the configuration, the interactive assignment system determines a correct characterization of the property in block 1704. The system may determine the correct characterization in any suitable manner, including using any of the exemplary techniques described above. The correct characterization determined in block 1704 will be used by the interactive assignment system as one of the options to be presented to the student for the multiple choice problem.

In block 1706, the interactive assignment system retrieves common mistakes with which the system is configured and applies the common mistakes to produce incorrect characterizations. The interactive assignment system may apply any suitable common mistakes to the correct characterization to generate incorrect characterizations, including by randomly selecting common mistakes from the set of common mistakes and determining whether the mistakes are relevant to the property to which the desired solution relates. If a common mistake is determined to be relevant, then the mistake may be applied to generate an incorrect characterizations. The system may determine whether a common mistake is relevant and apply the common mistake in any suitable manner, including according to techniques discussed above in connection with FIG. 16. Additionally, it should be appreciated that embodiments may select common mistakes to evaluate in block 1706 in any suitable manner, as embodiments are not limited in this respect. In some embodiments, as mentioned above, the common mistakes may be randomly selected, which may enable the system to generate different sets of incorrect multiple choice options each time the problem is to be presented. In other embodiments, the common mistakes may be selected according to an order, such as a sequential order according to an order of mistakes in a data structure that stores the mistakes for interactive assignment system.

Through applying the common mistakes that are determined to be relevant to the property to which the desired solution relates, the interactive assignment system generates one or more incorrect characterizations that may be used as incorrect options in the multiple choice problem.

Following the generation of the correct characterization in block 1704 and the incorrect characterization(s) in block 1706, the interactive assignment system stores the correct and incorrect characterizations in block 1708. Once the characterizations are stored in block 1708, the process 1700 ends. Following the process 1700, the correct and incorrect characterizations may be presented to a student in an interface of the interactive assignment system. When the interface is presented, the student may select any of the options to provide an input to the system and thereby attempt to solve the problem that is presented.

In the example of FIG. 17 described above, the interactive assignment system was described as generating the correct and incorrect characterizations for the multiple choice options in response to a student requesting that a problem to be presented. It should be appreciated, however, that embodiments are not limited to determining correct and incorrect characterizations for multiple choice options at any particular time. Embodiments are not limited to determining the characterizations in response to a student requesting that a problem be presented. Rather, in some embodiments, the interactive assignment system may determine the multiple choice options in response to an instructor providing input regarding a model, identifying a property to which a desired solution relates, and identifying that the problem is to be presented as a multiple choice problem. When such input is received from the instructor in these embodiments, correct and incorrect characterizations may be generated by the interactive assignment system using a process similar to the process of FIG. 17. Once the characterizations are generated in these embodiments, the characterizations may be stored as a part of the configuration of the problem.

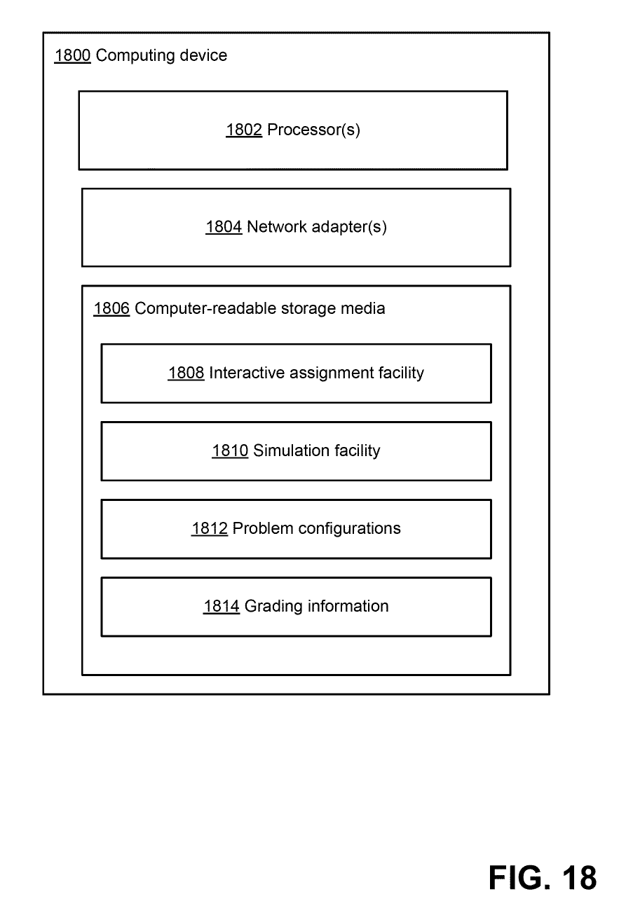

As discussed above in connection with FIG. 1, embodiments are not limited to operating with any particular computing device or type of computing device. FIG. 18 illustrates one exemplary implementation of a computing device in the form of a computing device 1800 that may be used in a system implementing techniques described herein, although others are possible. It should be appreciated that FIG. 18 is intended neither to be a depiction of necessary components for a computing device to execute an interactive assignment system in accordance with the principles described herein, nor a comprehensive depiction.

Computing device 1800 may comprise at least one processor 1802, a network adapter 1804, and computer-readable storage media 1806. Computing device 1800 may be, for example, a desktop or laptop personal computer, a personal digital assistant (PDA), a smart mobile phone, a server, a wireless access point or other networking element, or any other suitable computing device. Network adapter 1804 may be any suitable hardware and/or software to enable the computing device 1800 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1806 may be adapted to store data to be processed and/or instructions to be executed by processor 1802. Processor 1802 enables processing of data and execution of instructions. The data and instructions may be stored on the computer-readable storage media 1806.

The data and instructions stored on computer-readable storage media 1806 may comprise computer-executable instructions implementing techniques which operate according to the principles described herein. In the example of FIG. 18, computer-readable storage media 1806 stores computer-executable instructions implementing various facilities and storing various information as described above. Computer-readable storage media 1806 may store an interactive assignment facility 1808, which may include instructions for implementing any of the exemplary techniques for an interactive assignment system described herein. Computer-readable storage media 1806 may also store a simulation facility 1810, which may include instructions for implementing operations related to simulating a model and determining characterizations of one or more properties of a model, including using any of the exemplary techniques discussed above. The computer-readable storage media 1806 may also include a data store 1812 of problem configurations, which may include information on one or more problems, including any of the exemplary types of information regarding problems described above. Additionally, the computer-readable storage media 1808 may include a data store 1814 of grading information, which may include information on input provided by one or more students in response to problems, whether the input was correct or incorrect, and a grade assigned to the input by an interactive assignment system.

While not illustrated in FIG. 18, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A method of operating an interactive assignment system to configure a problem to be presented via the interactive assignment system, the interactive assignment system operating on at least one computing device and comprising a simulation system to simulate interactions of objects in a model of the problem and to determine an effect of interactions of objects in the model, the method comprising:
configuring the model of the problem based at least in part on user input, the configuring comprising storing information indicating that a value of a property of the model is to be randomly selected when the simulation system is to simulate the model; and
configuring the problem with a desired solution that is to be input to the interactive assignment system as a solution to the problem, in response to receipt of user input indicating the desired solution.

2. The method of claim 1, further comprising:
outputting the problem for presentation via the interactive assignment system, the outputting comprising:
retrieving a configuration of the model of the problem from storage, the configuration indicating that the value of the property is to be randomly selected;
randomly selecting the value of the property in accordance with the configuration;
rendering the model for display; and
outputting a rendering of the model and a prompt for the desired solution for presentation via the interactive assignment system.

3. The method of claim 2, wherein:
configuring the model of the problem and configuring the problem with the desired solution comprises configuring based at least in part on input received from an instructor of a course; and
outputting the problem for presentation via the interactive assignment system comprises outputting the problem for presentation to a student of the course.

4. The method of claim 1, wherein:
configuring the model further comprises:
adding a first object to the model in response to user input identifying the first object,
adding a second object to the model in response to user input identifying the second object; and
storing information indicating that the value of the property of the model is to be randomly selected comprises storing information indicating that a location of interaction between the first object and the second object is to be randomly selected.

5. The method of claim 4, wherein:
the first object defines a finite set of potential interaction locations at which the first object and the second object can interact; and
storing information indicating that the location of interaction is to be randomly selected comprises storing information indicating that the location of interaction is to be randomly selected from the finite set of potential interaction locations.

6. The method of claim 5, wherein:
the method further comprises receiving user input indicating that the location of interaction should be randomly selected from a subset of the finite set of potential interaction locations, the user input indicating at least one limitation that defines the subset; and
storing information indicating that the location of interaction is to be randomly selected comprises storing information indicating that the location of interaction is to be randomly selected from the subset of potential interaction locations.

7. The method of claim 1, wherein:
configuring the model further comprises:
adding a first object to the model in response to user input identifying the first object, and
adding a second object to the model in response to user input identifying the second object;
configuring the model of the problem further comprises:
configuring, in response to user input, the model with one or more object properties of the first object, and
configuring, in response to user input, the model with one or more object properties of the second object; and
the simulation system is configured to simulate an effect of an interaction of the first object and the second object based at least in part on the one or more object properties of the first object and the one or more object properties of the second object.

8. The method of claim 7, wherein:
the first and second objects of the model represent physical objects of a scenario to be simulated by the model, the one or more object properties of the first object and the one or more object properties of the second object corresponding to physical attributes of the physical objects represented by the first and second objects;
the simulation system is configured with physical laws governing interactions of physical objects and is configured to simulate interactions of the objects of the model according to the physical laws;
the simulation system is configured to simulate an effect of interaction of the first object and the second object based at least in part on the physical laws, the one or more object properties of the first object, and the one or more object properties of the second object; and
the method further comprises applying a function representing a physical law and taking into account at least one of the one or more object properties of the first object to determine the effect of interaction of the first object and the second object.

9. The method of claim 1, wherein:
the simulation system comprises a library of objects for inclusion in models, the library being organized into a plurality of scenario categories, each scenario category being associated with a category of scenario that may be simulated by the simulation system and a set of one or more physical laws that may be used by the simulation system to simulate interactions of objects in that scenario category;
the method further comprises:
receiving user input identifying a scenario category of the plurality of scenario categories, and
presenting to the user, via a graphical user interface, a plurality of objects that may be selected for inclusion in the model, the plurality of objects comprising a first object; and
adding a first object to the model in response to a user selection of the first object in the graphical user interface.

10. The method of claim 1, wherein configuring the problem with the desired solution in response to receipt of user input indicating the desired solution comprises:
receiving, from the user, a description of the desired solution, the description not containing the desired solution; and
determining, using the simulation system, whether the desired solution is determinable using the model.

11. The method of claim 10, wherein:
configuring the model further comprises:
adding a first object to the model in response to user input identifying the first object, and
adding a second object to the model in response to user input identifying the second object;
determining whether the desired solution is determinable comprises determining, using the simulation system, the desired solution described by the description by simulating interaction of at least the first object and the second object.

12. The method of claim 11, wherein:
receiving the description of the desired solution comprises receiving an identification of a property of the model and/or of the first object of the model, the desired solution being a numeric value of the property; and
determining the desired solution comprises calculating, using the simulation system, a numeric value of the property.

13. The method of claim 11, wherein:
receiving the description of the desired solution comprises receiving an identification of a property of the model and/or of the first object of the model, the desired solution being an equation defining the property; and
determining the desired solution comprises calculating, using the simulation system, the equation characterizing the property.

14. The method of claim 1, further comprising:
receiving from the user an indication of a type of desired solution, the type of desired solution being one of a group of types of desired solutions consisting of numeric value, equation, selection from multiple choice, and free-body diagram defined using the simulation system.

15. The method of claim 1, wherein:
the simulation system comprises a library of objects for inclusion in models, the library being organized into a plurality of scenario categories, each scenario category being associated with a category of scenario that may be simulated by the simulation system and a set of one or more physical laws that may be used by the simulation system to simulate interactions of objects in that scenario category, each scenario category being further associated with at least one common property of the model for which the simulation system is to automatically determine characterizations;
the method further comprises:
receiving user input identifying a scenario category of the plurality of scenario categories, and
following the configuring of the model, determining a characterization for each of the at least one common property associated with the scenario category identified by the user input, wherein determining the characterization for a common property comprises applying a function representing a physical law of the set of one or more physical laws associated with the scenario category.

16. At least one computer-readable storage medium having encoded thereon computer-executable instructions that, when executed by at least one computer, cause the at least one computer to carry out a method of operating an interactive assignment system to configure a problem to be presented via the interactive assignment system, the interactive assignment system operating on at least one computing device and comprising a simulation system to simulate interactions of objects in a model of the problem and to determine an effect of interactions of objects in the model, the method comprising:
configuring the model of the problem based at least in part on user input, the configuring comprising storing information indicating that a value of a property of the model is to be randomly selected when the simulation system is to simulate the model; and
configuring the problem with a desired solution that is to be input to the interactive assignment system as a solution to the problem, in response to receipt of user input indicating the desired solution.

17. The at least one computer-readable storage medium of claim 16, wherein the method further comprises:
outputting the problem for presentation via the interactive assignment system, the outputting comprising:
retrieving a configuration of the model of the problem from storage, the configuration indicating that the value of the property is to be randomly selected;
randomly selecting the value of the property in accordance with the configuration;
rendering the model for display; and
outputting a rendering of the model and a prompt for the desired solution for presentation via the interactive assignment system.

18. The at least one computer-readable storage medium of claim 16, wherein:
configuring the model further comprises:
adding a first object to the model in response to user input identifying the first object,
adding a second object to the model in response to user input identifying the second object; and
storing information indicating that the value of the property of the model is to be randomly selected comprises storing information indicating that a location of interaction between the first object and the second object is to be randomly selected.

19. The at least one computer-readable storage medium of claim 18, wherein:
the first object defines a finite set of potential interaction locations at which the first object and the second object can interact; and
storing information indicating that the location of interaction is to be randomly selected comprises storing information indicating that the location of interaction is to be randomly selected from the finite set of potential interaction locations.

20. The at least one computer-readable storage medium of claim 19, wherein:
the method further comprises receiving user input indicating that the location of interaction should be randomly selected from a subset of the finite set of potential interaction locations, the user input indicating at least one limitation that defines the subset; and
storing information indicating that the location of interaction is to be randomly selected comprises storing information indicating that the location of interaction is to be randomly selected from the subset of potential interaction locations.

21. The at least one computer-readable storage medium of claim 16, wherein:
configuring the model further comprises:
adding a first object to the model in response to user input identifying the first object, and
adding a second object to the model in response to user input identifying the second object;
configuring the model of the problem further comprises:
configuring, in response to user input, the model with one or more object properties of the first object, and
configuring, in response to user input, the model with one or more object properties of the second object; and
the simulation system is configured to simulate an effect of an interaction of the first object and the second object based at least in part on the one or more object properties of the first object and the one or more object properties of the second object.

22. The at least one computer-readable storage medium of claim 16, wherein configuring the problem with the desired solution in response to receipt of user input indicating the desired solution comprises:
receiving, from the user, a description of the desired solution, the description not containing the desired solution; and
determining, using the simulation system, whether the desired solution is determinable using the model.

23. The at least one computer-readable storage medium of claim 22, wherein:
configuring the model further comprises:
adding a first object to the model in response to user input identifying the first object, and
adding a second object to the model in response to user input identifying the second object;
determining whether the desired solution is determinable comprises determining, using the simulation system, the desired solution described by the description by simulating interaction of at least the first object and the second object.

24. A method for generating a problem to be presented via an interactive assignment system operating on at least one computing device, the interactive assignment system comprising a simulation system to simulate interactions of objects in a model and to determine an effect of interactions of objects in the model, the method comprising:
receiving a configuration of the model of the problem, the configuration indicating that a property of the model is to be randomly selected;
randomly selecting a value of the property of the model in accordance with the configuration;
rendering the model for display; and
outputting the problem for presentation via the interactive assignment system, the outputting comprising outputting a rendering of the model and a prompt for a desired solution to the problem.

25. The method of claim 24, wherein:
the model includes the first object and the second object and the configuration indicates that a location of an interaction between the first object and the second object is to be randomly selected;
randomly selecting the property of the model comprises randomly selecting the location of the interaction in accordance with the configuration; and
rendering the model for display comprises rendering such that the first object and second object are shown interacting at the randomly-selected location of interaction.

26. The method of claim 25, wherein:
the first object defines a finite set of potential interaction locations at which the first object and the second object can interact; and
randomly selecting the location of interaction between the first object and the second object comprises randomly selecting the location of interaction from the finite set of potential interaction locations.

27. The method of claim 25, wherein:
receiving the configuration comprises receiving a configuration indicating that the location of interaction should be randomly selected from a subset of the finite set of potential interaction locations, the configuration indicating at least one limitation that defines the subset; and
randomly selecting the location of interaction between the first object and the second object comprises randomly selecting the location from the subset of potential interaction locations.

28. The method of claim 24, wherein:
receiving the configuration comprises receiving a configuration created based on input received from an instructor of a course; and
outputting the problem for presentation via the interactive assignment system comprises outputting the problem for presentation to a student of the course.

29. The method of claim 24, wherein outputting the problem for presentation via the interactive assignment system comprises displaying the rendering and the description of the desired solution via a graphical user interface of the interactive assignment system.

30. The method of claim 24, wherein:
the property has a finite set of potential values; and
randomly selecting the value of the property comprises randomly selecting the values from the finite set of potential values.

31. The method of claim 30, wherein:
receiving the configuration comprises receiving a configuration indicating that the value of the property should be randomly selected from a subset of the finite set of potential values, the configuration indicating at least one limitation that defines the subset; and
randomly selecting the value of the property comprises randomly selecting the value from the subset of potential values.

32. The method of claim 24, wherein:
the receiving, randomly selecting, rendering, and outputting are performed each time a user requests that the interactive assignment system present the problem; and
randomly selecting the value of the property comprises:
randomly selecting, for a first user, a first value for the property, and
randomly selecting, for a second user, a second value for the property,
the first value being different from the second value.

33. The method of claim 32, wherein:
receiving the configuration comprises receiving a description of the desired solution to the problem, the description identifying a first property of the model to which the desired solution relates;
the method further comprises, each time a user requests that the interactive assignment system present the problem, determining, using the simulation system and following the randomly selecting, a characterization of the first property to which the desired solution relates; and
determining the characterization comprises determining a first characterization for the first user based at least in part on the first value and determining a second characterization for the second user based at least in part on the second value, the first characterization being different from the second characterization.

34. The method of claim 33, wherein:
the desired solution is a numeric value of the first property;
determining the first characterization of the first property comprises calculating a first numeric value of the first property for the first user based at least in part on the first value of the property; and
determining the second characterization of the first property comprises calculating a second numeric value of the first property for the second user based at least in part on the second value of the property,
the first numeric value being different from the second numeric value.

35. The method of claim 33, wherein:
the desired solution is an equation characterizing the first property to which the desired solution relates;
determining the first characterization of the first property comprises determining a first equation for the first user, the first equation characterizing the first property; and
determining the second characterization of the first property comprises determining a second equation for the second user, the second equation characterizing the first property.

36. The method of claim 33, wherein:
the desired solution is an equation characterizing the first property;
determining the first characterization of the first property comprises calculating a first numeric value for the first user based at least in part on the first value of the property; and
determining the second characterization of the first property comprises calculating a second numeric value for the second user based at least in part on the second value of the property,
the first value being different from the second value.

37. An apparatus comprising:
at least one processor; and
at least one storage medium having encoded thereon executable instructions that, when executed by at least one processor, cause the at least one processor to carry out a method for generating a problem to be presented via an interactive assignment system, the interactive assignment system comprising a simulation system to simulate interactions of objects in a model and to determine an effect of interactions of objects in the model, the method comprising:
receiving a configuration of the model of the problem, the configuration indicating that a property of the model is to be randomly selected;
randomly selecting a value of the property of the model in accordance with the configuration;
rendering the model for display; and
outputting the problem for presentation via the interactive assignment system, the outputting comprising outputting a rendering of the model and a prompt for a solution to the problem.

38. The apparatus of claim 37, wherein:
the model includes the first object and the second object and the configuration indicates that a location of an interaction between the first object and the second object is to be randomly selected;
randomly selecting the property of the model comprises randomly selecting the location of the interaction in accordance with the configuration; and
rendering the model for display comprises rendering such that the first object and second object are shown interacting at the randomly-selected location of interaction.

39. The apparatus of claim 37, wherein:
the property has a finite set of potential values; and
randomly selecting the value of the property comprises randomly selecting the values from the finite set of potential values.

40. The apparatus of claim 39, wherein:
receiving the configuration comprises receiving a configuration indicating that the value of the property should be randomly selected from a subset of the finite set of potential values, the configuration indicating at least one limitation that defines the subset; and
randomly selecting the value of the property comprises randomly selecting the value from the subset of potential values.

41. The apparatus of claim 37, wherein:
the receiving, randomly selecting, rendering, and outputting are performed each time a user requests that the interactive assignment system present the problem; and
randomly selecting the value of the property comprises:
randomly selecting, for a first user, a first value for the property, and
randomly selecting, for a second user, a second value for the property,
the first value being different from the second value.

42. The apparatus of claim 41, wherein:
receiving the configuration comprises receiving a description of the solution to the problem, the description identifying a first property of the model to which the solution relates;
the method further comprises, each time a user requests that the interactive assignment system present the problem, determining, using the simulation system and following the randomly selecting, a characterization of the first property to which the solution relates; and
determining the characterization comprises determining a first characterization for the first user based at least in part on the first value and determining a second characterization for the second user based at least in part on the second value, the first characterization being different from the second characterization.
